(19) United States
(12) Patent Application Publication
(10) Pub. No.: US 2004/0167952 A1
(43) Pub. Date: Aug. 26, 2004

(54) Method and apparatus for carrying out efficiently arithmetic computations in hardware

(76) Inventors: Shay Gueron, Haifa (IL); Isaac Hadad, Berr-Sheva (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/481,573

(22) PCT Filed: Apr. 22, 2002
(86) PCT No.: PCT/IL02/00318

(30) Foreign Application Priority Data
Jun. 21, 2001 (IL) 143951

(51) Int. Cl. G06F 7/00

(52) U.S. Cl. 708/492

(57) ABSTRACT

A method for carrying out modular arithmetic computations involving multiplication operations by utilizing a non-reduced and extended Montgomery multiplication between a first A and a second B integer values, in which the number of iterations required is greater than the number of bits n of an odd modulo value N. The method comprises storing n+2 bit values in an accumulating device (S) capable of, of adding n+2 bit values (X) to it content, and of dividing its content by 2. Whenever desired, the content of the accumulating device is set to zero value. At least s(>n+1) iterations of the following steps are performed, while in each iteration choosing one bit, in sequence, from the value of said first integer value A, starting from its least significant bit: adding to the content of the accumulating device S the product of the selected bit and said second integer value B; adding to the resulting content the product of its current least significant bit and N; dividing the result by 2; and obtaining a non-reduced and extended Montgomery multiplication result by repeating these steps s−1 additional times while in each time using the previous result (S).

### FIELD OF THE INVENTION

The present invention relates to the field of fast and efficient implementation of modular arithmetics in hardware. More particularly, the invention relates to a method and apparatus for carrying out modular arithmetic operations such as modular multiplication and exponentiation, utilizing Montgomery and straightforward methods.

### BACKGROUND OF THE INVENTION

The core operations of modern Public Key Cryptosystems (PKC) are typically based on performing modular arithmetic functions, in particular modular exponentiation, where modular exponentiation is essentially based on sequences of modular multiplications and modular squares. Consequently, fast methods for performing modular arithmetic functions, particularly in hardware, are of great importance for practical implementation of PKC. The Montgomery method offers an efficient way of carrying out some modular operations, most important of which is modular exponentiation. The advantage of this method is mostly appreciated in hardware implementations of modular exponentiation. Thus, the Montgomery method is widely adopted in implementations of PKCs that implement, for example, RSA, Digital Signature Standard (DSS), Diffie-Hellman (DF) key exchange, and Eliptic Curve Cryptography (ECC) algorithms (“Handbooks of Applied Cryptography” by Alfred J. Menezes, Paul C. van Oorschot and Scott A. Vanstone, CRC Press October 1996).

Montgomery Multiplication, Definition: Given the n-bit integers A, B, and N (N>A,B, N is odd), the Montgomery multiplication M(A,B,N,n), denoted also by MMUL(A,B) (for short), is defined by:

MMUL(A,B)=A*B*2⁻ⁿ modN

Which yields a reduced result ie., 0<MMUL(A, B)<N.

Notations: In the following discussion, the bits of integer values, such as the n-bit integer A=(Aₙ₋₁, . . . , A₁, A₀)₂, are represented utilizing the notation A₁ (0≦i≦n−1), wherein the Most Significant Bit (MSB) Aₙ₋₁ is the leftmost bit, ad the Least Significant Bit (LSB) A₀ is the rightmost bit, of the integer value A. Additionally, the value of a given variable S, in the j-th iteration, is denoted by S₍ⱼ₎. The notations of modular results, such as A*B mod N, refer to their reduced value in the range [0, N).

An algorithm for computing Montgomery multiplication (in radix 2) can be carried out by the following steps:

Algorithm 1:

Input: A, B, N, n (Precondition: A, B, N are n-bit integers, satisfying
N > A,B and N is odd)
Output: MMUL(A,B) = A*B*2⁻ⁿ modN

S=0
For I from 0 to n−1 do

| | |
|---|---|
| 1.1 | S=S+A₁*B |
| 1.2 | S=S+S₀*N |
| 1.3 | S=S/2 |

End for

| | |
|---|---|
| 1.4 | If S>N Then S=S−N |

Return S

The algorithm main loop requires only a series of additions (steps 1.1 and 1.2) and divisions by 2 (step 1.3). Step 1.4, called herein the reduction step, is an essential step without which the output of the algorithm, S, is not necessarily reduced.

### EXAMPLE 1

Table 1 illustrates this process of computing MMUL (A, B) for A=18=(10010)₂, B=12=(01100)₂, with N=19=(01100)₂. In this example n=5 the Montgomery multiplication is 18*12*2⁻⁵ mod19=2

TABLE 1
(Precondition: S = 0, A = 18, B = 12, and N = 19)

| I | A_{I} | S = S + A_{I} * B | S₀ | S = (S + S₀ * N)/2 |
|---|---|---|---|---|
| 0 | 0 | 0 | 0 | 0 |
| 1 | 1 | 12 | 0 | 6 |
| 2 | 0 | 6 | 0 | 3 |
| 3 | 0 | 3 | 1 | 11 |
| 4 | 1 | 23 | 1 | 21 |

Without step 1.4, the output of the algorithm, S, is not necessarily in the range [0, N). In particular, S may be of more than n bits. Thus, the additional reduction (S=S−N) (step 1.4) is sometimes required in order to shift the algorithm's output to the range [0, N). In Example 1 above, the calculation result is S=21>N, and thus the additional reduction S=S−N=21−19=2 is required in this case. In the case where A,B<N, as assumed, it can be shown (by induction) that before the reduction step (1.4) the result, S, is bounded by N+B. Thus, in the cases where S>N, after the iteration steps 1.1, 1.2, and 1.3, the additional reduction step 1.4 (S=S−N), that is performed at most only once, is sufficient to reduce the final result to the range [0, N), and therefore to ensure the desired result S=,A*B*2⁻ⁿ modN is indeed the output of the algorithm.

This Montgomery multiplication algorithm, which computes MMUL(A,B) can be used for computing the regular modular multiplication A*B modN. This can be carried out in more than one way, as illustrated in the following steps:

Method 1:

Input: A, B, N, A' (A, B, and N are n-bit integers, pre-computed value:
A′=A*2ⁿ modN)
Output: A*B modN

T=MMUL(A′,B)
Return T

For example, for the case of A=18, B=12, N=19, and n=5, the auxiliary value A′=18*25 mod19=6 is pre-computed, and is then used to calculate:

T=MMUL(A′,B)=6*12*2⁻⁵ mod19=7

Method 2:

Input: A, B, N, A', B' (A, B, and N are n-bit integers,
pre-computed values:
A′=A*2ⁿ modN and B′=B*2ⁿ modN)
Output: A * B modN

T=MMUL(A′,B′)
T=MMUL(T,1)
Return T

For example, for the case of A=18, B=12, N=19, and n=5, two auxiliary values are pre-computed: A′=18*2⁵ mod19=6 and B′=12*2⁵ mod19=4 which are then used to calculate: T=MMUL(A′,B′)=6*4*2⁻⁵ mod19=15 and finally, the result is computed by:

T=MMUL(T,1)=15*1*2⁻⁵ mod19=7

Method 2 involves the computation of auxiliary values, A′ and B′. This transforms the integers A and B to what is called the “Montgomery base”. The first Montgomery multiplication is applied to the transformed numbers, resulting in:

T=MMUL(A′,B′)=A′*B′*2⁻ⁿ modN=A*B*2ⁿ modN

This corresponds to the regular modular multiplication in the regular representation of A and B.

The second Montgomery multiplication (by 1) converts the result back to the regular base representation. In other words, it removes the redundant 2ⁿ factor from the above result, T=MMUL(A′,B′), thus obtaining the requested result:

T=MMUL(T,1)=(A*B*2ⁿ)*1*2⁻ⁿ modN=A*B modN

The overhead involved with Method 1 (computing the auxiliary value) is the main reason for which the Montgomery algorithm is not necessarily considered useful for computing a single modular multiplication, in comparison with a direct approach. However, Method 2 can be used efficiently when several modular multiplications are required. After converting the input to the Montgomery base, all multiplications are performed by means of the Montgomery multiplication algorithm, and the result is converted to the regular base at the end of the multiplications sequence. In such cases, the computational overhead of Method 2 is negligible, and the Montgomery algorithm substantially improves the efficiency in the overall calculations. The most typical example is the computation of the modular exponent A^{E} modN (for an m-bit integer value exponent E, where with no lose of generality, we assume here that A<d, utilizing Method 2 and the Montgomery multiplication. The exponentiation result can be computed, for example, as described hereinbelow (left-to-right binary exponentiation):

Algorithm 2:

Input: A, E, N
Output: A^{E} modN

T₍ₘ₋₁₎=A′=A*2ⁿ modN
For I from m−2 to 0 do

| | |
|---|---|
| 2.1 | T_{(I)}=MMUL(T_{(I+1),T(I+1)}) |
| 2.2 | if E₁=1 then T_{(I)}=MMUL(T₍₁₎,A′) |

| End for | |
|---|---|
| 2.3 | T₍₀₎=MMUL(T₍₀₎,1) |

Return T₍₀₎

The computation of the pre-calculated value A′=A*2ⁿ modN (0≦A′<N) converts the input to the Montgomery base, the Montgomery multiplications and squaring (steps 2.1 and 2.2) correspond to the sequence of multiplications and squaring that implement the left-to-right binary exponentiation in the regular base, and the Montgomery multiplication by 1 (step 2.3) converts the result back to the regular base. Reduction (step 1.4) in intermediate steps, in each Montgomery multiplication implemented by algorithm 1, is required in order to make sure that the result remains bounded by N. The reduction is of vital importance in implementation of such chained algorithms, since it assures that the input to the subsequent Montgomery multiplication is properly bounded. If reduction is not performed, and the result of one Montgomery multiplication (without the reduction step) exceeds N, overflow or erroneous results may occur in subsequent steps.

The main advantage in using the Montgomery multiplication lies in the hardware implementation of this multiplication operation. The MMUL algorithm requires, in each step, only the LSB of the accumulating result (step 1.2 above S=S+S₀*N).

The following example demonstrates an exponentiation operation carried out utilizing the algorithm described hereinabove. In this example the calculation of 212²⁴⁰ mod249=241 is computed.

### EXAMPLE 2

Table 2 illustrates the calculation of A^{E} modN, for n-bits values A and N, and the m-bit value E, utilizing the algorithm herein above. In table 2, the value obtained in the preceding step T_{(I+1)} is followed by the result obtained in step 2.1 T_{I+1)}², and the result obtained in step 2.2, T_{(I)}. In this example A=212, E=240=(1110000)₂, and N=249. Hence, A is of n=8 bits, E is of m=8 bits, and the pre-calculated value required is A′=212*2⁸ mod 249=239:

TABLE 2
(Precondition: A = 212, E = 240 = (11110000)₂, N = 249, and
T₍₇₎ = A′ = 239)

| I | E_{I} | T_{(I+1)} | T_{(I+1)}² | T_{(I)} |
|---|---|---|---|---|
| 6 | 1 | 239 | 370 − 249 = 121 | 254 − 249 = 5 |
| 5 | 1 | 5 | 217 | 437 − 249 = 188 |
| 4 | 1 | 188 | 247 | 323 − 249 = 74 |
| 3 | 0 | 74 | 142 | 142 |
| 2 | 0 | 142 | 106 | 106 |
| 1 | 0 | 106 | 289 − 249 = 40 | 40 |
| 0 | 0 | 40 | 193 | 193 |

And the final result is obtained by computing T₍₀₎MMUL(T₍ₒ₎,1)=193*1*2⁻⁸ mod249=241.

In this example, the Montgomery multiplication MMUL(A,B) is utilized for the calculation of Montgomery multiplication, Montgomery square, and Montgomery multiplication by 1. As was previously discussed, before the reduction step (1.4), the accumulated result may be greater than N, and reduction may be required in order to obtain the (correctly reduced) results of the Montgomery multiplication.

In Example 2, for I=6, 5, and 4, reduction was required in performing MMUL(T_{(I)},A′), and for I=1 and 6 in performing MMUL(T_{(I+1)},T_{(I+1)}).

It should be noted that the need for reductions substantially complicates hardware realizations of such apparatus, particularly when the number of bits n is significantly large (e.g., n=512). Dedicated circuitry is required for detecting the cases where the result is greater than N, and for performing the appropriate subtraction (i.e., the required reduction).

Efficient implementations of integer multiplication, achieved by indirect methods that avoid actual multiplication, are known in the literature (e.g., K. Hwang, Computer Arithmetic; Principles, Architecture, and Design, Wiley, New-York, 1979; Chapter 5). Such methods obtain the multiplication result by means of successive additions of appropriately pre-chosen quantities. For example, the value S=S+M*A, where M is of m=2 bits long, can be obtained without directly computing the product M*A, by using only additions of three pre-stored quantities, as follows. The quantity to be added to the accumulator depends on one of the four possible cases M=(0,0), M=(0,1), M=(1,0), M=(1,1):

If M=(0,0), nothing is added to the accumulator S.

If M=(0,1), the value A is added to the accumulator S.

If M=(1,0), the value 2*A is added to the accumulator S.

If M=(1,1), the value 3*A=A+2*A is added to the accumulator S.

Thus, the sum S=S+M*A can be obtained in one operation, by identifying the appropriate case (a 1:4 multiplexer in hardware) and adding, accordingly, either 0, A, 2*A or 3*A to the accumulator. The additional storage of A, 2*A and 3*A may be bypassed at the cost of (cumbersome) setting the hardware control accordingly: adding 2*A may be implemented by shifting the stored value of A and then feeding it to the accumulator, and adding 3*A may be implemented by adding the value of A and the shifted value of A to the accumulator.

Consequently, optimizing this operation requires balancing between storage and speed/hardware requirements. The extra storage of the values A, 2*A, 3*A may be advantageous if the same operation is repeated many times. For example, the computation of S=S+K*A when K is of k bits long, can be achieved iteratively. In each of (1+[k/m])=(1+[k/2]) iterations, the m=2 next bits of K are scanned and define a temporary value of M (m-bit portions of M), with which the above method is used. The number of bits m, designates the bit length of those temporary values (portions of M), and thus also define the number of right shifts that should be performed to the addition result S=S K*A. Analogous methods use larger values of m, more storage or hardware/control, but a smaller number (1+[k/m]) of iterations. The same method can be used when the value M*A+L*B is to be added to the accumulator, in order to compute S=S+M*A+L*B. In such case, scanning m bits of M and L in each iteration yields 2^{2m} combinations for the quantity that is to be added.

For example, with m=2, the 2^{2*2}=16 combinations for the added quantity are: 0, A, 2*A, 3*A, B, 2*B, 3*B, A+B, A+2*B, A+3*B, 2*A+B, 2*(A+B), 2*-A+3*B, 3*A+B, 3*A+2*B,3*(A+B). Storage of 15 quantities is needed unless extra hardware/control is used for adding 2(A+B) and/or adding 3(A+B) by using the stored value of (A+B). For n=1, there are 2^{2*1}=4 combinations namely: 0, A, B, A+B. The case m=1 is illustrated in FIG. 1 for carrying out multiplication and summation operations of four integers, A, B, C, and D. The apparatus depicted in FIG. 1 utilizes three registers R0, R1, and R2, a 1:4 multiplexer (MUX), and a Carry Save Adder (CSA), to carry out the calculation of A*B+C*D+G The registers R0 and R2, are n-bits each, while register R1 is of n+1 bits. Each of the registers, R0, R1, and R2, is connected to one of the MUX's inputs, In2, In3, and In1, respectively, while the MUX's input In0 is constantly fed by a “0” value (an n-bit value).

The multiplexer MUX has two control inputs, C0 and C1, such that for each state of the control inputs, C0 and C1, a corresponding input is selected, and output on the MUX's output (out). The calculation of A*B+C*D+G is carried out by loading registers R0, R1, R2, and the CSA with the values of D, B+D, B, and G, respectively, and serially feeding the data bits of A and C (A₁ and C_{I} (I=0,1,2, . . . ,n−1)), through the MUX's control inputs, C0 and C1 respectively.

The CSA is of n+2 bits, to allow over flow of 2 bits, and it is utilized for adding the value of the selected input (In0,In1,In2, or In3), retrieved via the MUX's output out, to its present content. The result of this addition is stored in the CSA, which is then subject to a right shift performed to the CSA content. Shifting the bits of an even binary value to the right is equivalent to the division of that value by 2 (in step 1.3 above). Thus, in each cycle in the operation of this system, the following operations are performed

1) selection of the respective value on In0, In1, In2, and In3;

2) addition of the selected value with the current content of the CSA register; and

3) right shifting the CSA bits, which also introduce the LSB of the CSA (i.e., CSA₀) on the CSA₀ output.

To implement Steps 1 and 2, the bits of A and C, A₁ and C₁ (I=0,1,2, . . . ,n−1), are serially introduced on the MUX's control inputs, C0 and C1, starting with the LSBs. Consequently, the MUX's output out₍₁₎ may take any of the following values in each and every iteration I:

$${out}_{( I )} = \{ \begin{matrix}0 & if & {A}_{I} = {C}_{I} = 0 & & \\ B & if & {A}_{I} = 1 & and & {C}_{I} = 0 \\ D & if & {A}_{I} = 0 & and & {C}_{I} = 1 \\ B + D & if & {A}_{I} = {C}_{I} = 1 & & \end{matrix} ; ( I = 0 , 1 , 2 , … n - 1 )$$

The process of calculating A*B+C*D+G is further described by the following pseudo-code.

D → R0_{;} B+D → R1_{;} B → R2 _{;}G →CSA
For I from 0 to n−1 Do

CSA_{(I+1)}=(CSA_{(I)}+out_{(I)})/2

End For

After n iterations the CSA's content (CSA₍ₙ₋₁₎) holds the n+1 Most Significant Bits (MSB) of the calculated result, and another n LSBs, of the calculated result, are obtained on the CSA₀ output, during the iterations. The CSA's content may be output utilizing a parallel output bus (not illustrated), or alternatively, by resetting the MUX's control inputs (i.e., set C0=C1=0), and performing n+1 additional iterations, to output the n+1 MSBs of the result, on the CSA₀ output (serial approach). The main drawback of the serial approach is that it is time-consuming (the addition of n+1 cycles is required to obtain the CSA content). On the other hand, although performance is significantly improved utilizing the parallel approach, it is considered costly in terms of hardware means.

This apparatus is efficiently utilized to perform Montgomery multiplication by applying the Montgomery method, as described in Patent Application WO 98/50851 and U.S. Pat. No. 6,185,596. In those patent applications a precomputed constant (J=−N⁻¹ mod 2ⁿ) is utilized to calculate in each iteration the number of times, Y=(A*B*J) mod2ⁿ, that modulus N should be added to the multiplication of A*B. This method requires testing, after each iteration of the Montgomery process, if the addition result exceeds the modulus value N. In such cases, the result does not exceed 2*N. Consequently, dedicated hardware is utilized in those implementations for testing the result in each iteration, and for subtracting the modulus value N from the result, whenever it exceeds the modulus value.

Methods for implementing modular multiplication by using the Montgomery multiplication as known in the art, are mainly affected—in both time and hardware—by the need to reduce the output resulting values, to values which are smaller than N. Furthermore, the reduction step, being dependent on the specific input (via the “if” statement) makes this implementation susceptible to (side channels) attacks. Therefore, although the Montgomery multiplication method enables efficient hardware implementation of modular arithmetic operations, such as modular exponentiation, there is a need for improving the hardware implementations of such operations. This may be achieved utilizing a method and an apparatus that does not require repeated reduction after each Montgomery multiplication.

It is an object of the present invention to provide a method and apparatus for carrying out a modified version of Montgomery multiplication in which the intermediate and the final calculation results do not exceed known bounds, and wherein no reduction is required during a chained sequence of such modified Montgomery multiplication, such as the sequence required for an exponentiation process, and the final result of the exponentiation process, is automatically reduced (between 0 and N).

It is another object of the present invention to provide a method and apparatus (called also a PKI apparatus herein) allowing efficient hardware implementations of modular exponentiation, and other modular arithmetic operations, based or not based on the Montgomery multiplication, which include the basic operations required for hardware implementation of public key cryptosystems.

It is yet another object of the present invention to provide a method and apparatus allowing efficient hardware implementations of various modular exponentiation algorithms such as right-to-left, left-to-right, m-array, and sliding-window exponentiation algorithms.

It is a still further object of the present invention to provide a method and apparatus for a secure PKI apparatus, based on a non-reduced and modified Montgomery multiplication, which is proof against timing attacks.

### SUMMARY OF THE INVENTION

In one aspect the present invention is directed to a method for cog out modular arithmetic computations involving multiplication operations by utilizing a non-reduced and extended Montgomery multiplication between a first A and a second B integer values, in which the number of iterations required is greater than the number of bits n of an odd modulo value N, the method comprising:

a) providing an accumulating device (S) capable of storing n+2 bit values, of adding n+2-bit values (X) to it content (S+X→S), and of dividing its content by 2 (S/2→S);

b) whenever desired, setting the content of the device to a zero value (“0”→S) and performing in the device at least s(>n+1) iterations, while in each iteration choosing one bit, in sequence, from the value of the first integer value A (A₁; 0≦s≦s−1), starting from its least significant bit (A₀):

b.1) adding to the content of the device S the product of the selected bit A₁ and the second integer value B (S+A₁*B→S);

b.2) adding to the resulting content of the device the product of its current least significant bit S₀ and N (S+S₀N→S);

b.3) dividing the resulting content of the device by 2 (S/2→S); and

b.4) obtaining a non-reduced and extended Montgomery multiplication result by repeating steps b.1) to b.3) s−1 additional times while in each time using the previous result (S).

The Montgomery multiplication result can be obtained by Dog steps b.1) to b.3) into a single step, by providing a first storing device (R2) for storing the modulo value N, a second storing device (R0) for storing the value of the second integer B, a third storing device (R1) for storing the sum of the modulo N and the second integer value B, providing an arbitration circuitry having a first (In1), second (In2) and third (In3), inputs from the first (R2), second (R0) and third (R1), storage devices respectively, and having an additional zero input (In0), the arbitration device receives a first (C1) and a second (C0) control inputs, and is capable of selecting one of its other inputs as it output, such that:

whenever its first (C1) and second (C0) control inputs are zero, selecting the additional zero input (In0);

whenever its first control input (C1) is one and its second control input (C0) is zero, selecting its second input (In2);

whenever its first control input (C1) is zero and its second control input (C0) is one, selecting its first input (In1); and

whenever its first (C1) and second (C0) control inputs are one, selecting the third input (In3);

wherein the selected input is provided as the output of the arbitration circuitry which is attached to the input of the accumulating device. The computation is carried out by applying the bits of the first integer value A (A₁; 0≦I≦s), one by one, in sequence, starting from its least significant bit (A₀), to the first control input (C1), and providing circuitry for producing the state (K₁) of the second control input (C0) according to the state of the selected bit of the first integer value, (A₁), the state of the least significant bit of the second integer value (B₀), and according to the state of the least significant bit of the accumulating device (S₀).

The state (K₁) of the second control input (C0) can be produced by producing a value of one (K₁=“1”) whenever the state of the first control input (C1) and the state of the least significant bit of the second integer value (B₀) are one, and the state of the least significant bit of the accumulating device (S₀) is zero, or when the state of the first control input (C1) and the state of the least significant bit (B₀) of the second integer value B are in different state, and the state of the least significant bit (S₀) of the accumulating device is one, otherwise a zero value (K₁=“0”) is produced as the state (K₁) of the second control input (C0).

The state of the second control input (C0) can be produced by circuitry comprising a logical AND gate, and a logical XOR gate, where the inputs of the logical AND gate are receiving the states of the first control input (C1) and the state of the least significant bit (B₀) of the second integer value B, and where the inputs of the logical XOR gate are receiving the output from the logical AND gate and the state of the least significant bit of the accumulating device (S₀), and where the output of the logical XOR gate is utilized as the state of the second control input (C0).

Preferably, the number of iterations s utilized for caring out the Montgomery multiplication is n+2, thereby an extended Montgomery multiplication result is obtained, in which n+2 iterations are performed.

The method may further comprise allowing modular arithmetic operations to be carried out, by utilizing for the first (R2), second (R0), and third (R1) storage devices an n+2 bits shift registers having a serial input into their most significant bit locations, and which may be capable of outputting their content in parallel, providing the first storage device (R2) with a serial output, from its least significant bit location (R2₀), and allowing it to perform cyclic bit rotation, allowing the second storage device (R0) to receive on its serial input the least significant bit (S₀) of the accumulating device, providing a fourth storage device (R3) capable of serially outputting it content, bit by bit in sequence (R3₁ J=0,1,2, . . . , n+1), starting from its least significant bit (R3₀), the fourth storage device is capable of storing n+2 bits, and of performing cyclic bit rotation to it content, providing a fifth storage device (R4) having a serial input and a serial output, and which is capable of storing values of n+2 bits, providing a sixth storage device (R5) capable of serially outputting it content, bit by bit in sequence (R5₁ I=0,1,2, . . . , n+1), starting from its least significant bit, the fob storage device is capable of storing n+2 bits, providing a first arbitration device (MX1) having a first input from the fifth storage device (R4₁), and a second input from the circuitry producing the state of the second control input (K₁), the output of the first arbitration device is attached to the second control input (C0), providing a second arbitration device (MX2) having a first input being equal to the least significant bit of the accumulating device (S₀, and also referred herein as CSA₀), a second input received from the output of the circuitry (K₁), and a third input connected to the serial output (R4₁) of the fish storage device (R4), the output of the second arbitration device is attached to the serial input of the fifth storage device (R4), providing a third arbitration device (MX3) having a first input which is constantly fed with a zero value (“0”), and a second input received from the serial output of the fifth storage device (R4₁), the output of the third arbitration device is connected to a serial input of the accumulating device, providing a fourth arbitration device (MX4) having a first input connected to the serial output of the sixth storage device (R5₁), and a second input connected to the serial output of the fourth storage device (R3₁), the output of the fourth arbitration device is connected to the first control input (C1), and providing an adder capable of performing serial addition of n+2 bit values, the adder receives a first input from the least significant bit location of the accumulating device (S₀), and a second input from the serial output of the first storage device (R2), the output of the adder is connected to the serial input of the third storage device (R1).

Preferably, the accumulating device consist of n+2 addition and latching stages, each of which consists of a first and a second flip flop devices and a full adder device having three inputs, except for the first stage wherein the second flip flop is excluded. In each addition and latching stages the first input of the full adder is connected to the output of a first flip-flop device, the second input of the full adder is connected to the output of a second flip flop device of the subsequent addition and latching stage; and the third input of the full adder is connected to the respective bit output of the arbitration device (MUX₁ 0≦i≦n+1).

The method may further comprise adding the output from the third arbitration device (MX3), via the serial input of the accumulating device, to the addition result of the (n+1)-th addition and latching stage by providing the (n+1)-th addition and latching stages with a first and second half adder devices, and a third flip flop device, connecting the input of the first flip flop device to the sum output of the second half adder, connecting the input of the second flip flop device to the carry output of the second half adder, and connecting the output of the flip device to the second: input of the full adder of the (n+2)-th addition and latching stage, connecting the first input of the second half adder to the carry output of the full adder of the (n+1)-th addition and latching stage, and it second input, to the carry output of the first half adder, connecting the first input of the first half adder to the sum output of the full adder, and connecting the second input of the second half adder to the output of the third arbitration device (MX3); and connecting the input of the third flip flop device to the sum output of the first half adder, and connecting it output to the second input of the full adder of the (n−1)-th addition and latching stage.

The state of the second control input (C0) can be determined utilizing the least significant bit of the second storage device (R0), the output of the fourth arbitration device (MX4), the carry output of the full adder of the first addition and latching stage, and the sum output of the full adder of the second addition and latching stage. Preferably it is carried out by connecting the least significant bit of the second storage device (R0) and the output of the fourth arbitration device (MX4), to the inputs of an AND logical gate, providing an additional half adder and an additional flip flop device, connecting the first input of the half adder to the sum output of the full adder of the second addition and latching stage, and its second input to the carry output of the full adder of the first addition and latching stage, connecting the sum output of the half adder to the input of the additional flip flop device, and connecting the output of the AND logical gate and the output of the flip flop device to the inputs of a XOR gate, and utilizing the output of the XOR gate to determine the state of the second control input (C0).

The method may further comprise carrying out non-reduced Montgomery squaring of an integer value BR by loading the first (R2), second (R0), and third (R1), storage devices with the values of the modulus N, the integer B, and the sum of the modulus and the integer (N+B), respectively, setting the first (MX1), second (MX2), third (MX3) and fourth (MX4), arbitration devices to select the inputs of the circuitry for producing the state (K₁) of the second control input (C0), the circuitry for producing the state (K₁) of the second control input (C0), the zero value (“0”), and the output of the sixth storage device (R5), respectively, loading the content of the sixth storage device (R5) with the content of the second storage device (R0), and loading the content of the accumulating device with a zero value, performing the non-reduced and extended Montgomery multiplication wherein the content of the sixth storage device (R5) is shifted by one bit to the right in each cycle, and obtaining the non-reduced Montgomery squaring result in the accumulating device.

The method may also comprise carrying out Montgomery multiplication of a first (A) and second (B) integer values, by loading the first (R2), second (R0), third (R1), and fourth (R8) storage devices with the values of the modulus N, the second integer (B), the sum of the modulus and the second integer (N+B), and the first integer (A), respectively, setting the first (MX1), second (MX2), third (MX3) and fourth (MX4), arbitration devices to select the inputs of the circuitry for producing the state (K₁) of the second control input (C0), the circuitry for producing the state (K₁) of the second control input (C0), the zero value (“0”), and the output of the fourth storage device (R3), respectively, loading the content of the accumulating device with a zero value, performing the non-reduced and extended Montgomery multiplication wherein the content of the fourth storage device (R3) is shifted by one bit to the right in each cycle, and obtaining the non-reduced Montgomery multiplication result in the accumulating device.

The computation of the modular exponentiation A^{E} modN can be carried out by pre-calculating an adjusted operand value A′=A*2^{E} modN, composing an adjusted value for the exponent E=(eₘ₋₁,eₘ₋₂, . . . , e₁,e₀) by reversing its bit order and eliminating the most significant bit eₘ₋₁, to obtain the adjusted value E′=(e₀,e₁, . . . , eₘ₋₂)₂, loading the content of the first, second, third, and fifth, storage devices with the values of the modulus N, the adjusted operand (A′), the sum of the modulus and the adjusted operand (N+A′), and the adjusted exponent value E′, respectively, obtaining the bit length m of the exponent value E and performing the following steps m−1 times:

right shifting the content of the fifth storage device (R4);

performing non-reduced Montgomery squaring to obtain the non-reduced Montgomery square of the content of the third storage device (R3) in the accumulating device;

loading the content of the third storage device (R3) with the content of the accumulating device; and

loading the content of the third storage device (R1) with the slum of the content of the first storage device (R2) and the content of the accumulating device;

if the least significant bit (R4₀) of the fifth storage device equals “1” performing non-reduced and extended Montgomery multiplication to obtain the non-reduced, Montgomery multiplication result of the contents of the second storage device (R0) and the fourth storage device (R3), in the accumulating device, loading the content of the second storage device (R0) with the content of the accumulating device, and loading the content of the third (R1) storage device with the sum of the contents of the first storage device (R2) and the accumulating device accumulating;

After repeating these steps m−1 times the modular exponentiation result is obtained by performing non-reduced and extended Montgomery multiplication of the content of the second storage device (R0) by 1 to obtain the final reduced result in the accumulating device.

Alternatively, the modular exponentiation A^{E} modN can be computed by pre-calculating the adjusted operand value A′=A*2^{s} modN, loading the content of the first (R2), second (R0), third (R1), and fifth (R4), storage devices with the values of the modulus N, the adjusted operand (A′), the sum of the modulus and the adjusted operand (N+A′), and the exponent value E, obtaining the bit length m of the exponent value E, setting a flag to “1”, and performing the following steps m−2 times:

right shifting the content of the fifth storage device (R4);

if the least significant bit (R4₀) of the fifth storage device equals “1” checking the state of the flag, and if it does not equal “1” performing non-reduced and extended Montgomery multiplication to obtain the non-reduced and extended Montgomery multiplication result of the contents of the second storage device (R0) and the fourth storage device (R3), in the accumulating device, loading the content of the fourth storage device (R3) with the content of the accumulating device, otherwise loading the content of the fourth storage device (R3) with the content of the second storage device (R0) and resetting the state of the flag to “0”;

performing extended and non-reduced Montgomery squaring to obtain the extended and non-reduced Montgomery square of the content of the second storage device (R0) in the accumulating device;

loading the content of the second storage device (R0) with the content of the accumulating device;

loading the content of the third storage device (R1) with the sum of the content of the first storage device and the content of the accumulating device; After performing these steps m−2 times performing extended and non-reduced Montgomery multiplication to obtain the extended and non-reduced Montgomery multiplication result of the contents of the second storage device (R0) and the fourth storage device (R3), in the accumulating device, loading the content of the second storage device (R0) with the content of the accumulating device, loading the content of the third storage device (R1) with the sum of the content of the first storage device (R2) and the content of the accumulating device, and performing extended and non-reduced Montgomery multiplication of the content of the second storage device (R0) by 1 to obtain the final reduced result in the accumulating device.

A modular multiplication of a first (A=A¹*2ⁿ+A⁰) and a second (B=B¹*2ⁿ+B⁰) integer values, where the first integer, second integer, and the modulus (N), are of 2×n bits, can be calculated by computing the Montgomery multiplication (MMUL(A⁰,B⁰)) of the n least significant bits of the first integer value (A⁰) and of the second integer value (B⁰), by performing the following steps:

loading the first (R2), second (R0), third (R1), and fourth (R3) storage devices, with the n least significant bits (N⁰) of the modulus value (N), the n least significant bits (BC) of the second integer value (B), the sum (B⁰+N⁰) of the n least significant bits of the modulus value (N) and of the n least significant bits (B⁰) of the second integer value (B), and the n least significant bits (A⁰) of the first integer value (A), respectively;

setting the first (MX1), second (MX2), third (MX3), and fourth (MX4, arbitration devices for selecting the input of the circuitry for producing the state (K₁) of the second control input (C0), the circuitry for producing the state (K₁) of the second control input (C0), the zero value (“0”), and the fourth storage device (R3) input, and resetting the content of the accumulating device to zero, if it is required;

carrying out Montgomery multiplication and obtaining the result (S₍₁₎) in the accumulating device, and the bits state (K_{I} 0≦I≦n−1) of the second control input (K⁰) in the fifth register (R4);

computing the value of A⁰*B¹+N¹*K⁰+S₍₁₎ of the n least significant bits of the first integer value (A⁰), the n most significant bits of the second integer value (B¹), the y most significant bits of the modulus value (N¹), the n-bit value (K⁰) obtained in the fifth register (R4), and the result obtained in step a) (S₍₁₎) by performing the following steps:

loading the first (R2), second (R0), third (R1), and fourth (R3) storage devices, with the n most significant bits (N¹) of the modulus value (N), the n most significant bits (B¹) of the second integer value (B), the sum (B¹+N¹) of the n most significant bits of the modulus value (N) and of the n most significant bits of the second integer value (B), and the n least significant bits (A⁰) of the first integer value (A), respectively;

setting the first (MX1), second (MX2), third (MX3), and fourth (MX4), arbitration devices for selecting the input of the fifth register (R4), the least significant bit of the accumulating device (S₀), the zero value (“0”), and the fourth storage device (R3) input;

carrying out regular multiplication and obtaining the most significant bits of the result in the accumulating device (S_{(II)}) and the least significant bits of the result in the fifth storage device (R(₄₎);

computing result of addition of the Montgomery multiplication of the n most significant bits of the first integer value (A¹) and the n least significant bits of the second integer value (B⁰), with the result that was previously obtained (R4_{(II)}, S_{(II)}), by performing the following steps:

loading the first (R2), second (R0), third (R1), and fourth (R3) storage devices, with the n least significant bits (N⁰) of the modulus value (N), the n least significant bits (B⁰) of the second integer value (B), the sum (B⁰+N⁰) of the n least significant bits of the modulus value (N) and of the n least significant bits (B⁰) of the second integer value (B), and the n most significant bits (A¹) of the first integer value (A), respectively;

loading the content of the accumulating device (S, also referred to as CSA herein) with the n least significant bits of the previously obtained result (R4(_{II)}), and loading the content of the fifth storage device (R4) with n most significant bits of the previously obtained result (S_{(II)});

setting the first (MX1), second (MX2), third (MX3), and fourth (MX4), arbitration devices for selecting the input of the circuitry for producing the state (K₁) of the second control input (C0), the circuitry for producing the state (K₁) of the second control input (C0), the input from the fifth storage device (R4), and the fourth storage device (R3) input;

carrying out Montgomery multiplication and obtaining the result (S_{(III)}) in the accumulating device, and the bits state (K₁ 0≦I≦n−1) of the second control input (K¹) in the fifth register (R4);

computing A¹*B¹+N¹*K¹+S_{(III)} of the n most significant bits of the first integer value (A¹), the n most significant bits of the second integer value (B¹), the n most significant bits of the modulus value (N¹), the n-bit value (K¹) obtained in the fifth register (R4), and the result obtained in step c) (S_{(III)}) by performing the following steps:

loading the first (R2), second (R0), third (R1), and fourth (R3) storage devices, with the n most significant bits (N¹) of the modulus value (N), the n most significant bits (B¹) of the second integer value (B), the sum (B¹+N¹) of the n most significant bits of the modulus value (N) and of the n most significant bits of the second integer value (B), and the n most significant bits (A¹) of the first integer value (A), respectively;

setting the first (MX1), second (MX2), third (MX3), and fourth (MX4), arbitration devices for selecting the input of the fifth register (R4), the least significant bit of the accumulating device (S₀), the zero value (“0”), and the fourth storage device (R3) input; and

carrying out Montgomery multiplication and obtaining the most significant bits of the result in the accumulating device (S_{(IV)}) and the least significant bits of the result in the fifth storage device (R_{(IV)}).

The method may further comprise carrying out modular multiplication of a first

$$( A = {\sum }_{i = 0}^{q - 1} {A}^{i} * {2}^{i} )$$

and a second

$$( B = {\sum }_{i = 0}^{q - 1} {B}^{i} * {2}^{i} )$$

integer values, where the first integer, second integer, and the modulus

$$( N = {\sum }_{i = 0}^{q - 1} {N}^{i} * {2}^{i} ) ,$$

may be of more than 2×n bits, where the computation is carried out by computing intermediate results of the multiplication of 2×n bits subsequent fractions of the first integer and second integer.

In another aspect the present invention is directed to an apparatus for carrying out extended and non-reduced Montgomery multiplication of a first (A) and second (B) integer values, in which the number of iterations (s) required is greater the number of bits (n) in the modulo value (N), and in which the Montgomery multiplication result is smaller than twice the modulo value (2×N), comprising:

a first storage device (R2) for storing the modulo value (N);

a second storage device (R0) for storing the value of the first integer values (A);

a third storage device (R1) for storing the sum of the first integer value and the modulo (A+N);

an arbitration circuitry having a first (In1), second (In2) and third (In3), inputs from the first (R2), second (R0), and third (R1), storage devices, and having a fourth input which is zero (“0”), the arbitration device receives a first (C1) and a second (C0) control inputs, and thereby is capable of selecting one of it other inputs as it output, that is attached to the input of the accumulating device;

circuitry for producing the state (K₁) of the second control input (C0) according to the state of a selected bit of the first integer value (A₁), the state of the least significant bit of the second integer value (B₀), and according to the state of the least significant bit of the accumulating device (S₀); and

an accumulating device (S) capable of storing n+2 bits values, of adding n+2-bits values) to it content (S+X→S), and of dividing it content by 2 (S/2→S);

Preferably, the circuitry utilized for producing the state (K₁) of the second control input comprises:

Circuitry for producing a value of one whenever:

the state of the selected bit (A₁) and the state of the least significant bit of the second integer value (B₀) are one, and the state of the least significant bit of the accumulating device (S₀) is zero; or

the state of the selected bit (A₁) and the state of the least significant bit (B₀) of the second integer value are in different state, and the state of the least significant bit (S₀) of the accumulating device is one;

the circuitry produces a zero value in all other cases.

The first (R2), second (R0), and third (R1) storage devices can be n+2 bits shift registers having a serial input into their most significant bit locations, and which may be capable of outputting their content in parallel. The first storage device (R2) may also have a serial output, from its least significant bit location (R2₀), allowing it to perform cyclic bit rotation.

The apparatus may further comprise means for allowing modular arithmetic operations to be carried out, comprising:

means for connecting the serial input of the second storage device (R0) to the least significant bit (S₀) of the accumulating device (S);

a fourth storage device (R3) capable of serially outputting it content, bit by bit in sequence (R3_{I} I=0,1,2, . . . , n+1), starting from its least significant bit (R3₀), the fourth storage device is capable of storing n+2 bits, and of performing cyclic bit rotation to it content;

a fifth storage device (R4) having a serial input and a serial output, and which is capable of storing values of n+2 bits;

a sixth storage device (R5) capable of serially outputting it content, bit by bit in sequence (R5_{I} I=0,1,2, . . . , n+1), starting from its least significant bit, the fourth storage device is capable of storing n+2 bits;

a first arbitration device (MX1) having a first input from the fifth storage device (R4₁), and a second input from the circuitry producing the state of the second control input (K₁), the output of the first arbitration device is attached to the second control input (C0);

a second arbitration device (MX2) having a first input being equal to the least significant bit of the accumulating device (S₀), a second input received from the output of the circuitry (K₁), and a third input connected to the serial output (R4₁) of the fifth storage device (R4), the output of the second arbitration device is attached to the serial input of the fifth storage device (R4);

a third arbitration device (MX3) having a first input which is constantly fed with a zero value (“0”), and a second input received from the serial output of the fifth storage device (R4₁), the output of the third arbitration device is connected to a serial input of the accumulating device;

a fourth arbitration device (MX4) having a fast input connected to the serial output of the sixth storage device (R5₁), and a second input connected to the serial output of the fourth storage device (R3₁), the output of the four arbitration device is connected to the first control input (C1); and

an adder capable of performing serial addition of n+2 bit values, the adder receives a first input from the least significant bit location of the accumulating device (S₀), and a second input from the serial output of the first storage device (R2), the output of the adder is connected to the serial input of the third storage device (R1).

The accumulating device may consist of n+2 addition and latching stages, each of which consists of a first and a second flip flop devices and a full adder device having three inputs, except for the first stage wherein the second flip flop is excluded, comprising:

a) means for connecting the first input of the full adder to the output of a first flip-flop device;

b) means for connecting the second input of the full adder to the output of a second flip flop device of the subsequent addition and latching stage; and

c) means for connecting the third input of the full adder to the respective bit output of the arbitration device (MUX₁ 0≦i≦n+1).

The accumulating device may further comprise means for adding the output from the third arbitration device (MX3), via the serial input of the accumulating device, to the addition result of the (n+1)-th addition and latching stage, comprising:

a) a first and second half adder devices, and a third flip flop device;

b) means for connecting the input of the first flip flop device to the sum output of the second half adder;

c) means for connecting the input of the second flip flop device to the carry output of the second half adder, and for connecting the output of the flip flop device to the second input of the full adder of the (n+2)-th addition and latching stage;

d) means for connecting the first input of the second half adder to the carry output of the full adder of the (n+1)-th addition and latching stage, and it second input, to the carry output of the first half adder;

e) means for connecting the first input of the first half adder to the sum output of the full adder, and for connecting the second input of the second half adder to the output of the third arbitration device (MX3); and

f) means for connecting the input of the third flip flop device to the sum output of the first half adder, and connecting it output to the second input of the full adder of the (n−1)-th addition and latching stage.

The state of the second control input (C0) is can be determined utilizing the least significant bit of the second storage device (R0), the output of the fourth arbitration device (MX4), the carry output of the full adder of the first addition and latching stage, and the sum output of the full adder of the second addition and latching stage, comprising:

a) means for connecting the least significant bit of the second storage device (R0) and the output of the fourth arbitration device (MX4), to the inputs of an AND logical gate;

b) an additional half adder and an additional flip flop device;

c) means for connecting the first input of the half adder to the sum output of the full adder of the second addition and latching stage, and its second input to the carry output of the full adder of the first addition and latching stage;

d) means for connecting the sum output of the half adder to the input of the additional flip flop device; and

e) means for connecting the output of the AND logical gate and the output of the flip flop device to the inputs of a XOR gate, and utilizing the output of the XOR gate to determine the state of the second control input (C0).

### BRIEF DESCRIPTION OF THE DRAWINGS

In the drawings:

FIG. 1 is a block diagram schematically illustrating a prior art apparatus for carrying out multiplication and addition operations;

FIG. 2 is a block diagram schematically illustrating a preferred embodiment of the invention for computing a non-reduced and extended Montgomery multiplication;

FIG. 3 schematically illustrates one preferred embodiment of the invention for generating the K₁ bit;

FIG. 4 is a block diagram schematically illustrating a preferred embodiment of the invention for carrying out modular arithmetic operations, utilizing Montgomery multiplication;

FIG. 5 schematically illustrates a process for computing interleaved Montgomery multiplication, according to a preferred embodiment of the invention;

FIGS. 6A and 6B schematically illustrates a possible embodiment of a CSA device according the method of the invention; and

FIGS. 7A and 7B are flowcharts illustrating methods for carrying out exponentiation by utilizing the PKI apparatus.

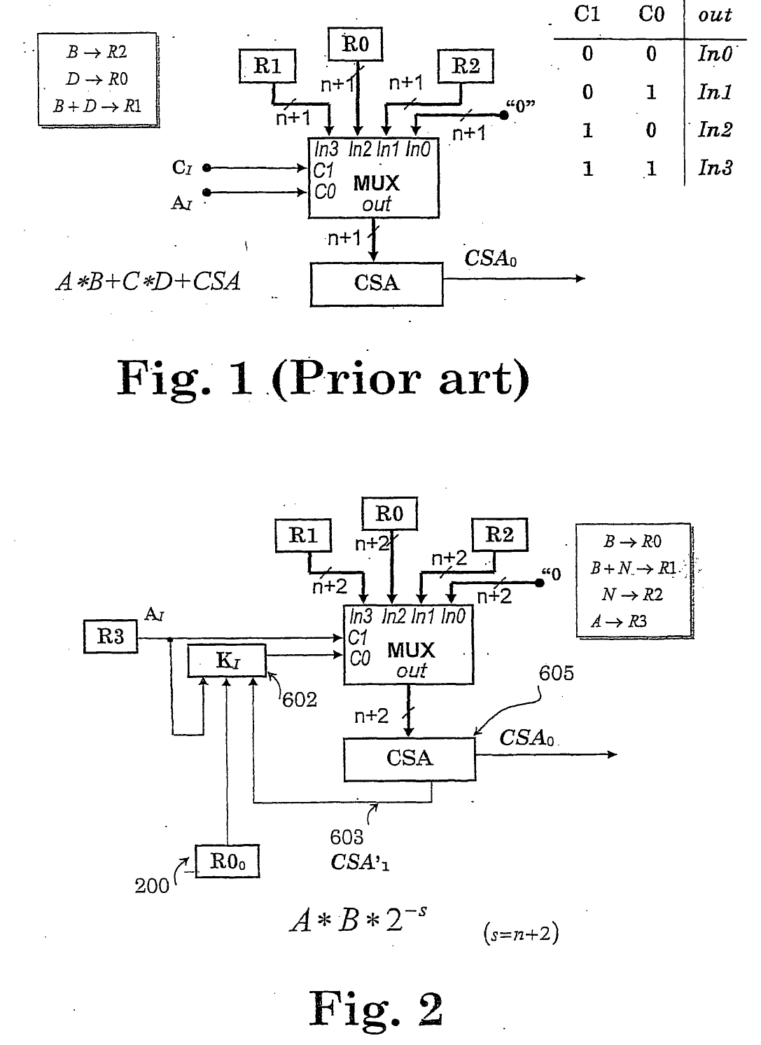

### DETAILED DESCRIPTION OF PREFERRED EMBODIMENTS

The present invention refers to a method and apparatus for carrying out modular arithmetic operations, which is fast and efficient in terms of hardware means. At the core of the preferred embodiment of the invention is the computation of the modular multiplication of two integers A and B modulo N (hereinafter A·B mod I), based on a modified (extended) Montgomery method.

A modified (extended) Montgomery multiplication—definition: For n bits long odd modulus N, integers A, B such that A,B≦2*N, and an integer s≧M, define the Non-Reduced and extended Montgomery Multiplication (NRMM) by NRMM(^{s})(A,B,N)=A*B*2^{-s} mod(N+ε*N), where ε=0 for a reduced result, and ε=1 for a non-reduced result. For short, when the context (i.e., N and s) is known, NRMM^{(s)}(A,B) will be used hereinafter to denote NRMM^{(s)}(A,B,N). The computation of NRMM^{(s)}(A,B) is carried out by repeating steps 1.1, 1.2, and 1.3, s(≧n) iterations, without performing the reduction step 1.4. Hereinafter the result of such computation is also termed as non-reduced and extended Montgomery multiplication. It is important to note that the result obtained by this non-reduced and extended Montgomery multiplication is not necessarily reduced (i.e., NRMM^{(s)}(A,B,N) may be greater that the modulus N).

A process for computing NRMM^{(s)}(A,B) is given by the following steps:

Process 1:

Input: A, B, N, s, n (Precondition: N is an n-bit integer
with A, B<2*N, N is
odd, and s≧n)
Output: NRMM^{(s)}(A,B)

S=0
For I from 0 to s−1 do

| | |
|---|---|
| 3.1. | S=S+A_{(I)}*B |
| 3.2. | S=S+S₀*N |
| 3.3. | S=S/2 |

End for
Return S

The special case where A, B<N and s=n is the classical Montgomery multiplication which is used in most applications where the final reduction step is ignored. According to the method of the invention this process is performed without performing reduction (step 1.4), and in a preferred embodiment of the invention, s=n+2 is utilized, wherein for inputs bounded by 2*N, the result obtained is also bounded by 2N, although it is sufficient to require that B<2*N and that A is not of more that n+1 bits.

The method of the present invention is based on the following facts: when performing s=n+2 iterations, with n bits long modulus N, (n+1) bits long input values A and B (where A; B<2*N), the final result of NRMM^{(s)}(A,B) does not exceeds 2*N, and the temporary accumulated results (step 3.2) do not exceed 6*N. This observation is of significant importance, since it allows for successive applications of this extended and non-reduced Montgomery Multiplication, in which the input and the output values are bounded by the same upper bound (2*N), thus eliminating potential overflows. As explained before, the exponentiation process A^{E} modN can be implemented by means of a sequence of Montgomery multiplications and Montgomery squaring. A MMUL(A,A) operation with an n bits long operand A (A<M may produce a non-reduced result larger than N but smaller than 2*N. Thus, non-reduced Montgomery Multiplication with s=n+2 rounds allows performing a continuous exponentiation sequence of NRMM^{(s)}s without a need for reduction in the intermediate steps, with storage registers of length (n+2) bits and accumulator capable of computing up to (n+3) bits results. As will be explained hereinafter, an implementation of (n+2) bits accumulator (CSA) may be utilized according to the method of the invention. Moreover, s=n+2 is the minimal number of rounds that guarantees such exponentiation without reduction.

The computation of the non reduced extended Montgomery multiplication is implicitly based on adding the value K·N (for some K≧0) to the product A*B. The value of K is not known in advance, and is constructed iteratively. In the preferred embodiment of the invention, in each iteration of the process, another bit K₁ of the integer K is computed, as will be described hereinafter. The modulus value N may be added to the product of A*B any number of times, and could still be considered as the same result modulo N, that is, the result after adding K*N yields the same residue modulo N if it is reduced to the range [0,N). The value of K is chosen in away that A*B+K*N is divisible by 2^{s}. The result A*B+K*N is divided by 2^{s} (shifted to the right s times), for disposing of s zeros from the result's LSBs. Thus, the result is actually the outcome of the s successive Right Shift (RSH^{s}) operation, RSH^{s}(A*B+K*N)=(A*B+K*N)/2^{s}, wherein RSH^{s}(X)=X*2^{-s} denotes s shifts of X to the right. These shifts are performed in each iteration (step 3.3).

The NRMM^{(s)} performed according to the method of the invention consists of s=n+2 iterations, in which a value is added to an accumulated result. The value that is added to the accumulated result, in each iteration, is chosen such that the temporary cumulative addition result of step 3.2 is an even number. Therefore, the LSB bit of the temporary value of the cumulative result is always zero, and it can be divided by 2 (step 3.3) by means of one right shift.

More particularly, whenever the computation result of S=S+A_{I}*B is an odd value, the (odd) modulus N is added to S. Thus, in each iteration the following calculation is performed

$$S = \{ \begin{matrix}S + {A}_{1} * B & if & S + {A}_{I} * B & even \\ S + {A}_{I} * B + N & if & S + {A}_{I} * B & odd\end{matrix} .$$

Therefore, the result may be always divided by 2, without a remainder (i.e., by a right shift).

According to a preferred embodiment of the invention, a modification of the classical Montgomery multiplication method is utilized to facilitate implementations for modular arithmetic computations, which can be realized completely by hardware. In prior art methods for computing the classical Montgomery multiplication, the computation of MMUL(A,B)=A*B*2⁻ⁿ modN is obtained in a process of n iterations, wherein n is the number of bits in the modulus N. There is a substantial advantage in performing more than n iterations in this computation, as previously discussed. In a preferred embodiment of the invention, s=n+2 is utilized, and the following arguments hold for this type of Montgomery multiplication:

When performing s=n+2 iterations to compute NRMM^{(s)}(A,B), with n bits long input values A and B, (A, B<N), and with n bits long modulus N, all the bits of A are scanned, the final result does not exceeds N+B<2*N and the temporary accumulated results do not exceed 2*(N+B)<4*N.

Moreover, when performing s=n+2 iterations to compute the non-reduced and extended NRMM^{(s)}(A,B), with (n+1) bits long input values A and B, (where A,B<2*N), and with n bits long modulus N, all the bits of A are scanned, the final result does not exceeds (N+B+N)/2<2*N and the temporary accumulated results do not exceed 2*(N+B)<6*N.

It is important to note that when performing s=TL+2 iterations to compute NRMM^{(s)}(A,1) with (n+1) bits long input value A (A<2*N), and with n bits long modulus N, all the bits of A are scanned, and the final result obtained is reduced, i.e., is smaller than N.

As a result, when a chained sequence of non-reduced Montgomery multiplications is performed, with an n bits long modulus N, and inputs that are bounded by 2*N, the outputs remain bounded by 2*N, and one (final) extended Montgomery multiplication by 1 reduces the result to the range [0,N) (without actually performing the reduction of step 1.4).

The latter observations are of significant importance in applications. As explained before, the exponentiation process A^{E} modN (A<N) can be implemented by means of a sequence of Montgomery multiplications and Montgomery squaring (MMUL(X,A), MMUL(X,X) operations, that even with an n bits long operand X (X<N), and certainly with an n+1 bits operand X<2*N, may produce a non-reduced result larger than N but smaller than 2*N. The modified Montgomery Multiplication (non-reduced) with s=n+2 rounds allows performing a continuous exponentiation sequence of NRMM^{(s)}s without a need for reduction in the intermediate steps, with storage registers of length (n+2) bits and accumulator of length (n+3) bits (i.e., an (n+2) bits long accumulator that includes one additional bit for a carry). Moreover, s=n+2 is the minimal number of rounds that guarantees such exponentiation without reduction

### EXAMPLE 3

in the following example the modified Montgomery Multiplication is utilized for calculating the exponent A^{E} modN, for A=212, E=240=(11110000)₂ (m=8), and N=249 (n=8, as in Example 2). The modified Montgomery multiplication is carried out by performing s=n+2=10 iterations, and thus the pre-calculation of A′=212*2¹⁰ mod 249=209 is required

TABLE 3
(Precondition: A = 212, E = 240 = (11110000)₂, N = 249,
and T₍₇₎ = A′ = 209)

| I | E_{I} | T_{(I+1)} | T_{(I+1)}² | T_{(I)} |
|---|---|---|---|---|
| 6 | 1 | 209 | 235 | 269 |
| 5 | 1 | 269 | 121 | 254 |
| 4 | 1 | 254 | 241 | 296 |
| 3 | 0 | 296 | 319 | 319 |
| 2 | 0 | 319 | 175 | 175 |
| 1 | 0 | 175 | 160 | 160 |
| 0 | 0 | 160 | 25 | 25 |

In table 2, the value obtained in the preceding step T_{(I+1)} is followed by the result obtained in step 2.1 T_{(I+1)}², and the result obtained in step 2.2, T_{(I)}. The final result is obtained by computing T₍₀₎=NRMM^{(s)}(T₍₀₎,1)=241. As shown, the results of the intermediate Montgomery multiplications that were performed were not reduced. In the operation of step 2.2 performed in iterations I=6, 5, 4, and 3, the results were NRMM^{(s)}(T₍₁₎,A′)>N, and for the operation of step 2.1 in the iteration I=3 the result NRMM^{(s)}(T_{I+1)},T_{(I+1)})>N. As discussed before, the non-reduced Montgomery multiplications are bounded, and do not exceed 2*N. Table 4 exemplifies the benefits of the modified Montgomery Multiplication, for the calculation of NRMM^{(s)}(319,319), as performed in step I=3 in Table 4 hereinabove.

TABLE 4
(Precondition: S = 0, A = 319 =
(100111111)₂, B = 319, and N = 249)

| I | A_{(I)} | S = S + A_{(I)} * B | S₀ | S = S + S₀ * N | S = S/2 |
|---|---|---|---|---|---|
| 0 | 1 | 319 | 1 | 568 | 284 |
| 1 | 1 | 603 | 1 | 852 | 426 |
| 2 | 1 | 745 | 1 | 994 | 497 |
| 3 | 1 | 816 | 0 | 816 | 408 |
| 4 | 1 | 727 | 1 | 976 | 488 |
| 5 | 1 | 807 | 1 | 1056 | 528 |
| 6 | 0 | 528 | 0 | 528 | 264 |
| 7 | 0 | 264 | 0 | 264 | 132 |
| 8 | 1 | 451 | 1 | 700 | 350 |
| 9 | 0 | 350 | 0 | 350 | 175 |

The result obtained is 319*319*2⁻¹⁰ mod249=175, and evidently all the temporary acccumulated results are bounded by 6N. It should be noted that for I=5 a temporary result of S=S+S₀*N=1056=(10000100000)₂ is obtained, which is of 11 bits (n+3). In fact, this is the maximal bit length that is required for such calculations utilizing the non-reduced Montgomery Multiplication, and therefore the CSA should be capable of computing results that are up to n+3 bits. However, due to the continuous right shifts that are performed in the CSA in each operation, it is implemented as an n+2 bit CSA.

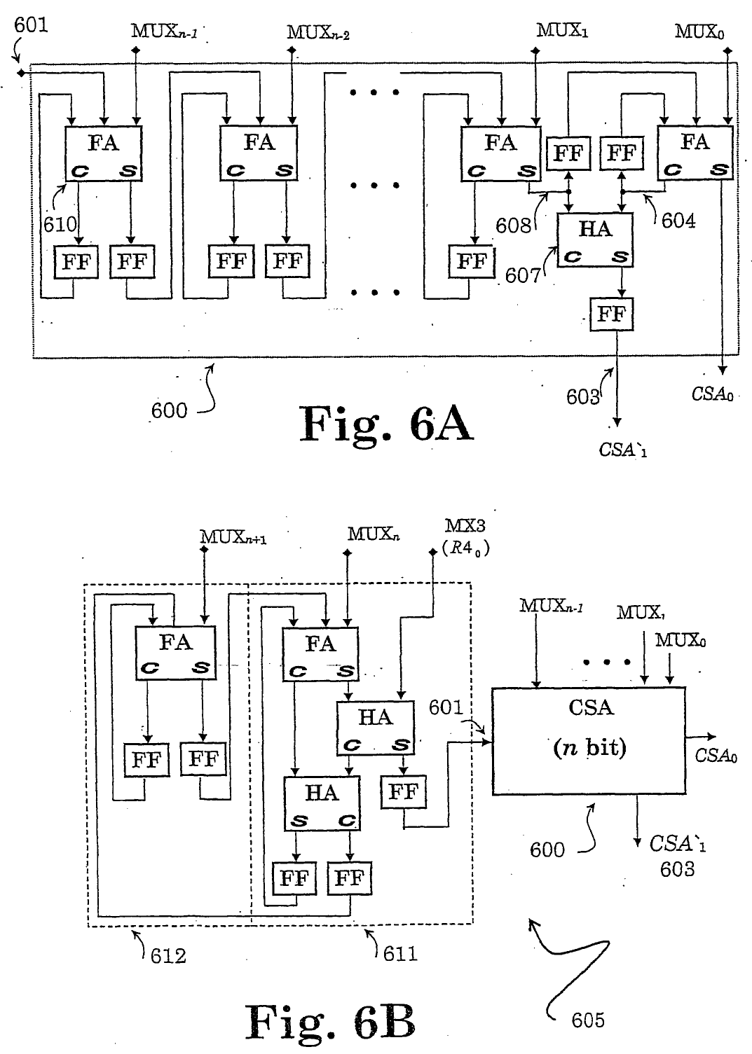

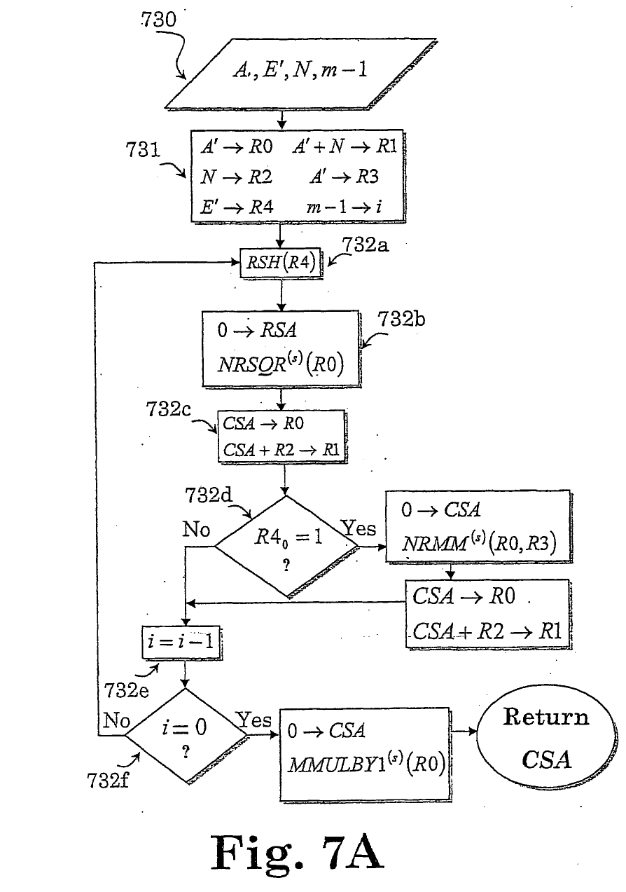

The K₁ bit takes the value S₀, the LSB of the partial result S=S+A₁*B, which is realized in each iteration. This value (K₁) is completely determined by the least significant bits of the results of the previous iteration, and other known values, and can be realized by K₁=(A₁·B₀)⊕CSA′₁, were CSA′₁ (603) is an output obtained from the CSA. As will be explained in details with reference to FIG. 6, with some additional hardware the CSA can provide the CSA′₁ (603) output which is used to speed up the process of producing the K₁ bit. This realization can be easily implemented in hardware. AL apparatus based on the determination of K₁, according to a preferred embodiment of the invention, is illustrated in FIG. 2. An additional shift register, R3, is used in this apparatus for feeding the A₁ bits of A. The R3 register has a serial output, and it consists of s bits for holding the value of A, in its n LSBs, and the two additional (zero) bits in its 2 leftmost MSB locations, which are utilized for carrying out two additional iterations (s=n+2). The CSA, which is of s+2 bits, acts as an additional storage device, and thus there is no need for an additional storage device for partial results that are obtained in intermediate steps.

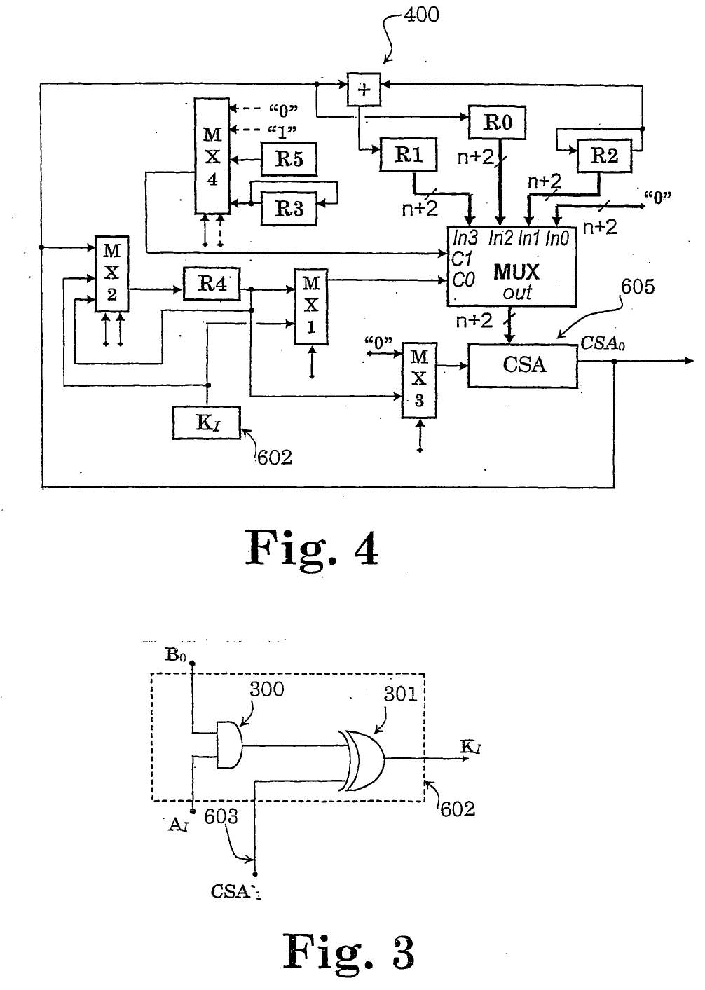

In the preferred embodiment of the invention, the value of K₁ is realized from the values of A₁, R0₀, and CSA′₁ (603). With reference to FIG. 2, the value of K₁ is realized utilizing appropriate circuitry 602 (for which a possible implementation is illustrated in FIG. 3), which receives A₁, R0₀, and CSA′₁, as inputs. The bit B₀ is placed in a latching device 200, which receives the LSB of register R0 (R0₀). To carry out the calculation of NRMM^{(s)}(A,B), the system is initialized by loading the values B, B+N, N, and A, into the respective registers, R0, R1, R2, and R3, and by zeroing the content of the CSA. Thus K₀ will equal “1” only if A₀=B₀=1.

It should be understood that when Montgomery Multiplication is performed, and N is odd, the content of the CSA is always even, which enables the division by 2 to be carried out by means of one right shift, without a remainder. In addition, the LSB of the CSA is obtained on the CSA₀ output, and hence, in case there is a remainder (regular multiplication), it is obtained on the CSA₀ output.

FIG. 3 demonstrates one possible implementation of a circuitry 602 for providing the K₁ bit. The realization in FIG. 3 is carried out utilizing an AND gate 300 and an Exclusive Or (XOR) gate 301, wherein the inputs of the AND gate are the bits A₁ and B₀, and the XOR gate inputs are the output of the AND gate 300, and CSA′₁ 603. The CSA′₁ 603 output from the CSA produces an expected value for the CSA LSB, and therefore speeds and simplifies the realization of the K₁ bit.

The method of the invention, as described and exemplified hereinabove, is utilized for a fast and efficient computation of the extended and non-reduced Montgomery multiplication NRMM^{(s)}(A,B), wherein A and B are smaller than 2*N, and N is up to n bits (and s≧n+2). This apparatus can be modified to allow modular products computation of integers, which have more the n-bits, which is also known as the Montgomery interleaved modular multiplication, as will be discussed later.

FIG. 4 depicts an apparatus, according to a preferred embodiment of the invention, for carrying out arithmetic operations based on the extended non-reduced Montgomery modular multiplication. The apparatus, also termed Public Key Interface (PKI) herein, is based on 6 registers (each of n+2 bits), R0, R1, R2, R3, R4, R5 and a Carry Save Adder (of n+2 bits), CSA, with some control (not shown). The PKI apparatus is capable of performing various arithmetic and modular arithmetic operations, as will explained hereinbelow.

In the apparatus of FIG. 4, the additional multiplexers, MX1, MX2, MX3 and MX4, and the shift registers R4 and R5, are introduced. The control input C1 of the MUX is connected to the output of MX4, which acts as an arbitrator for selecting between the serial outputs of registers R3 and R5. Registers R2, R3 and R4, have serial inputs and serial outputs, and are capable of performing cyclic bit rotation. The other MUX control input, C0, is connected to the output of MX1, which acts as an arbitrator to select the input value from register R4, or from the circuitry that produces the value K₁. The register R4 has a serial input, which is connected to the output of MX2, which acts as an arbitration for selecting between the input of the CSA value, the output of R4 (useful when cyclic bit rotation of R4 is performed), or the value of K₁ 602.

The third multiplexer, MX3, selects the input to the CSA serial input, and may select a “0” value or the output of MX4. The output of MX3 is added to the n-th bit of the CSA, so that in each step the CSA content is set by performing the calculation of CSA_{(I+1)}=(CSA₍₁₎+out_{(I)}+MX3_{(I)}*2ⁿ)/2 (where out_{(I)} and MX3_{(I)} are the outputs from the MUX and MX3 devices respectively), as will be discussed herein. It should be noted that register R5 is utilized only for carrying out squaring operations which are involved in more complex arithmetic computations (i.e., exponentiation). It will be shown that for performing squaring operation register R5 is loaded with the content of register R0. Therefore, one may implement the same apparatus without register R5, and read the subsequent bits of register R0 utilizing multiplexing techniques. A possible embodiment of the CSA is illustrated in FIGS. 6A and 6B.

The CSA illustrated in FIGS. 6A and 6B is based on a serial approach, wherein a set of n Full Adders (FA) are serially connected. The CSA 600 depicted in FIG. 6A is an n bits CSA, in which each FA has 3 inputs, and 2 outputs, a Carry (C) and Sum (S), each of which is the input of a Flip-Flop (FF) device. Each FA receives the following inputs: the output of the FF which receives the S output of the subsequent FA; the output of the FF which receives its own C output, and a corresponding input from the MUX (MUXₙ₋₁, MUXₙ₋₂, . . . MUX₀). In this way, the right-shift of the CSA content, and the addition of the MUX output, out, are effected. The leftmost FA device 610 receives an input from another two stages, 611 and 612, depicted in FIG. 6B.

The additional stages, 611 and 612, depicted in FIG. 6B are utilized to expand the n bit CSA 600 of FIG. 6A, into a (n+2) bit CSA The n-th stage 611 in FIG. 6B, is utilized for the addition of MX3₍₁₎*2ⁿ to the CSA content. Although it is shown that the addition of 4 bits is performed by the n-th stage 611, it should be understood that in practice only 3 bits are summed by this stage. More particularly, when performing the Montgomery based computations, the input received from MX3 is always in zero state, and when performing regular multiplication, which are part of an interleaved multiplication, the input received from the (n+1)-th stage 612 is in zero state.

To accelerate the system performance, the C output 604 of the first stage FA, and the S output 608 of the second stage FA, are connected to the Half Adder (HA) 607 which its S output is connected to a FF from which the output CSA′₁ 603 is provided for the circuitry utilized for determining K₁. The HA 607 may be replaced by a logical XOR gate, or any device capable of realizing the ⊕ operation (i.e., base 2 modular addition). It should be also noted that the serial output of the CSA, CSA₀ is not provided via an FF device, but instead it is obtained directly from the S output of the fist stage's FA.

The application of various arithmetic operations, according to a preferred embodiment of the invention, is described in the following discussion. While this is a limited set of operations, it does not limit the application of a wider set comprising other possible operations, utilizing the method of the invention, and is therefore introduced here only for the purpose of illustration.

Montgomery Square (NRSQR^{(s)})

The following process is utilized for the computation of CSA=(B*B+K*N+CSA)/2^{s}, and therefore provides the Non-Reduced and Extended Montgomery Squaring of an integer value B, NRMM^{(s)}(B,B). The number of rounds is s≧1, however it is shown that the optimal choice is s=n+2.

Input: B, N, s (B → R0, B + N → R1, N → R2)
Output: NRSQR^{(s)} = NRMM^{(s)} (B,B)

R0 → R5
For I from 0 to s-1 do

$\begin{matrix}{K}_{1} = LSB ( CSA + {R5}_{1} * {R0}_{0} ) \\ CSA = ( CSA + \{ \begin{matrix}0 & if & {R5}_{1} = 0 & {K}_{1} = 0 \\ R0 & if & {R5}_{1} = 1 & {K}_{1} = 0 \\ R2 & if & {R5}_{1} = 0 & {K}_{1} = 1 \\ R1 & if & {R5}_{1} = 1 & {K}_{1} = 1\end{matrix} ) / 2\end{matrix}$

End for
Return CSA

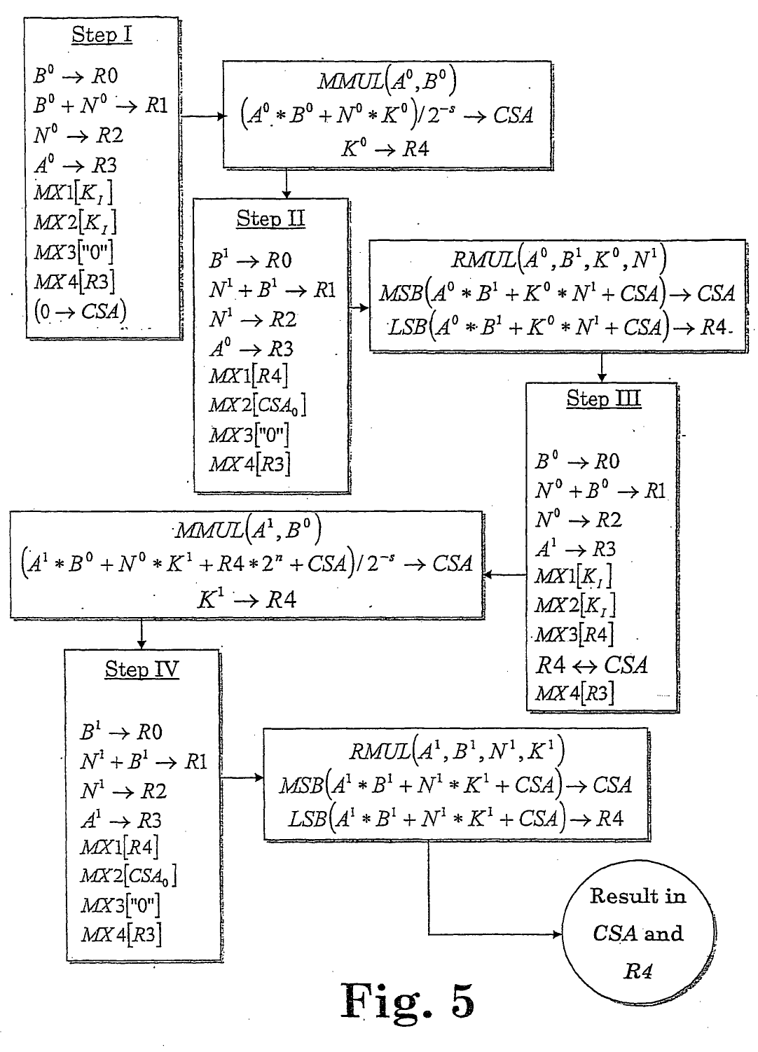

For this calculation, the control inputs of MX1, MX2, MX3, and MX4 are set to select the input of K₁, K₁, “0”, and R5 respectively. It should be noted that for this computation the input selection made for MX2 does not affect the result. When this operation is performed as part of an interleaved multiplication the control input of MX3 is set to select the R4 input. After performing s iterations, the value of K is obtained in the R4 register. The content of R5 may be loaded (FIG. 5) with the content of register R0, utilizing conventional parallel/serial techniques (not illustrated) or by software. It should be understood that the NRSQR process may be utilized to compute (B*B+K*N+CSA)/2^{s}, or (B*B+K*N)/2^{s} by zeroing the content of the CSA in the initialization steps.

Non-Reduced and Extended Montgomery Multiplication (NRMM^{(s)})

The non-reduced Montgomery multiplication implemented by the PKI apparatus, is described according to the method of the invention. The following process calculates the non-reduced result CSA (A*B+K*N+CSA)/2^{s}.

Input: A, B, N, s (A → R3, B → R0, B + N → R1, N → R2)
Output: NRMM^{(s)} (A,B)

For I from 0 to s-1 do

$\begin{matrix}{K}_{1} = LSB ( CSA + {R3}_{1} * {R0}_{0} ) \\ CSA = ( CSA + \{ \begin{matrix}0 & if & {R3}_{1} = 0 & {K}_{1} = 0 \\ R0 & if & {R3}_{1} = 1 & {K}_{1} = 0 \\ R2 & if & {R3}_{1} = 0 & {K}_{1} = 1 \\ R1 & if & {R3}_{1} = 1 & {K}_{1} = 1\end{matrix} ) / 2\end{matrix}$

End for
Return CSA

The control inputs of MX1 and MX4 are set to select the inputs of K₁ and R3, respectively. The control inputs of MX2 and MX3 are set to select the inputs of K₁ and “0”, respectively, when a simple NRMM^{(s)} is performed, or alternatively, the input of K₁ and R4, respectively, as part of an interleaved multiplication (illustrated in FIG. 5). As previously mentioned, the value of K is obtained in the R4 register as the s cycles of the calculation are completed. Of course the NRMM^{(s)} process may be also utilized to compute (A*B+K*N)/2^{s}, by zeroing the content of the CSA in the initialization steps.

Montgomery Multiplication by 1 (MMULBY1^{(s)})

The following process is utilized for computing CSA=(B+K*N+CSA)/2^{s}, for some value B, utilizing the PKI apparatus, according to the method of the invention. As previously explained, for B<2*N and s=n+2, the result obtained by the MMULBY1^{(s)}(B) operation is reduced (for B<2*N and s=n+2MMULBY1^{(s)}(B)<N).

Input: B, N, s (B → R0, B + N → R1, N → R2, 1 → R3)
Output: MMULBY1^{(s)}(B) = NRMM^{(s)}(B,1)

$\begin{matrix}{K}_{0} = LSB ( CSA + {R0}_{0} ) \\ CSA = ( CSA + \{ \begin{matrix}R0 & if & {K}_{0} = 0 \\ R1 & if & {K}_{0} = 1\end{matrix} ) / 2\end{matrix}$
For I from 1 to s-1 do

$\begin{matrix}{K}_{1} = {CSA}_{0} \\ CSA = ( CSA + \{ \begin{matrix}0 & if & {K}_{1} = 0 \\ R2 & if & {K}_{1} = 1\end{matrix} )\end{matrix}$

End for
Return CSA

The control inputs of MX1, MX3, and MX4 are set to select the input of K₁, “0”, and R3 respectively (the selection of MX2 does not affect this operation). The value of K is obtained in the R4 register, and the final result is obtained in the CSA, as the s cycles of the calculation are finished. It should be noted that instead of loading R3 with the value of 1 (n+2 bits), an external control may be utilized for forcing “1” at the MX4 output, at the first cycle, and “0” at the remaining cycles (illustrated by dashed lines in FIG. 4). As before, the computation of (B+K*N)/2^{s} can be obtained by zeroing the content of the CSA in the initialization steps.

Regular Multiplication (RMUL)

There are various ways of implementing regular multiplication utilizing the PKI apparatus, according to the method of the invention. The following process is one possible way for computing CSA: R4=A*B+C*D+CSA (the content of the CSA holds the results of the previously performed operation, or alternatively it may be set to a desired value). The MSB of the RMUL operation is obtained in the CSA, and the LSB in R4.

Input: A, B, C, D, n (B → R0, B + D → R1, D → R2,
A → R3, C → R4)
Output: RMUL(A, B, C, D) = A * B + C * D + CSA

For I from 0 to n-1 do

$CSA = ( CSA + \{ \begin{matrix}0 & if & {R3}_{1} = 0 & {R4}_{1} = 0 \\ R0 & if & {R3}_{1} = 1 & {R4}_{1} = 0 \\ R2 & if & {R3}_{1} = 0 & {R4}_{1} = 1 \\ R1 & if & {R3}_{1} = 1 & {R4}_{1} = 1\end{matrix} ) / 2$

R4 = R4/2 + CSA₀ * 2ⁿ⁻¹
CSA = CSA/2
End for
Return CSA & R4

The control inputs of MX1, MX2, MX3, and MX4 are set to select the inputs of R4, CSA₀, “0”, and R3, respectively. After performing n iterations, the n LSBs of the result are obtained in the register R4, and n MSBs of the result are obtained in the CSA.

Montgomery Exponent

The PKI application of an exponent calculation is based on the exponent process that was described hereinabove, for computing. A^{E} modN (A<N with no lose of generality). For carrying out this calculation with the PKI apparatus, the pre-calculated value A′=A*2^{s} modN is required. For this particular process, an adjusted (truncated) value E′ for the exponent E=(eₘ₋₁,eₘ₋₂, . . . , e₀) is required, wherein the MSB eₘ₋₁ is eliminated, and the bit order is reversed, thus obtaining E′=(e₀,e₁, . . . , eₘ₋₂)₂ (m is the number of bits in E).

process 2:

Input: m, A′, N, E′ (A′→R0, A′+N → R1 ,N → R2, A′ → R3, E′→ R4)
Output: CSA=A^{E} modN (left-to-right approach)

For I from 0 to m−2 do

| | 0→ CSA |
|---|---|
| 4.1. | R0=NRSÕR^{(s)}(r0) |
| 4.2. | R1=R0+R2 |
| 4.3. | If R4_{I}=1 than 0→CSA_{;} R0=NRMM^{(s)}(R0,R3)_{;} |

R1=R0+R2
End for
0→CSA
MMULBY1^{(s)}(R0)
Return CSA

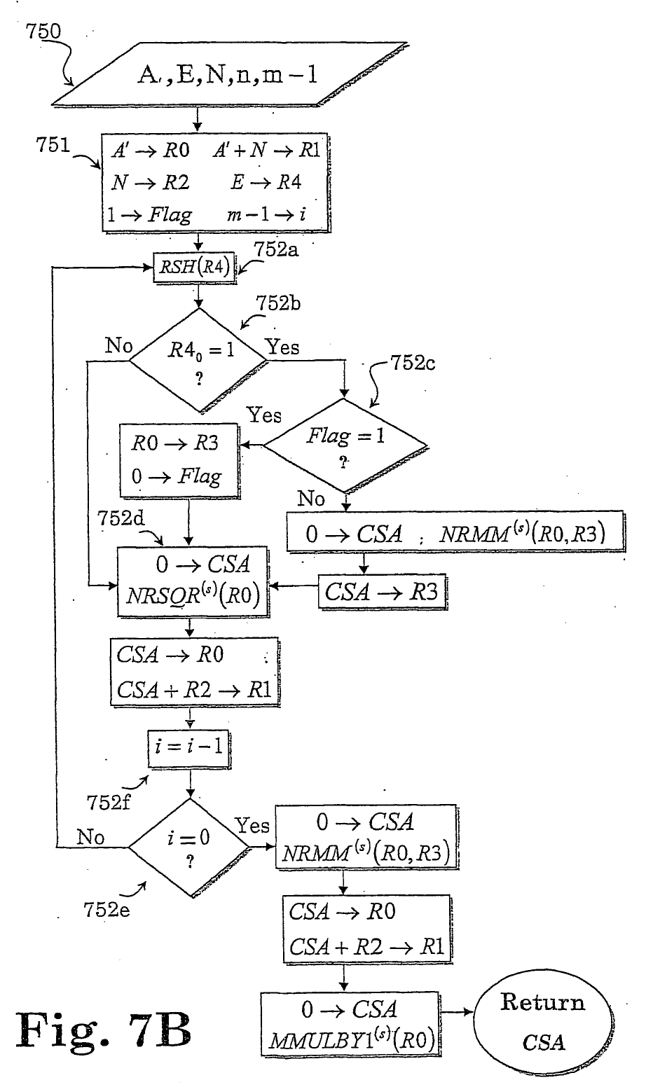

A sequence of Montgomery squaring and multiplication are performed in the loop, in the above process. The operation of the PKI apparatus utilizing process 2 is further illustrated in FIG. 7A, in a form of a flowchart. The operation is initiated in steps 730 and 731, in which the values A′,E′,N, and m−1 are input to the PKI apparatus. A sequence of operations (steps 4.1. to 4.3. here above) are performed in a loop starting in steps 732a and 732b, where a right shift is performed to the content of register R4, the CSA content is zeroed, and an NRMSQR^{(s)} of the content of R0 is performed. In step 732c the NRMSQR^{(s)} result, which is obtained in the CSA, is loaded into register R0, and the addition result of the content of the CSA and the register R2 is loaded into register R1.

The operation of step 4.3. of the exponent process hereinabove is carried out in step 732d, where the LSB of R4 is examined, and if it equals “1” the CSA content is zeroed and a NRMM^{(s)} of the content of registers R0 and R3 is performed, the result of which is then stored in R0 and also added to the content of R2 and stored in the register R1. The operation proceeds in step 732e, in which the value of the loop index i is decrement by 1, and in step 732f it is checked if the loop index i equals zero. If i is not zeroed another iteration of the process is performed, as the operation is proceeded in step 732a, otherwise, the CSA content is zeroed and a MMULBY1^{(s)} operation is performed to the content of R0. The exponentiation (reduced) result is obtained in the CSA after performing the MMULBY1^{(s)} operation to eliminate the 2^{s} element.

It should be understood that the process illustrated in FIG. 7A is carried out utilizing an external control (not shown). This control may be performed by software utilizing a processor/controller, or by the addition of dedicated hardware.

Other exponentiation processes, such as right-to-left binary exponentiation, m-array exponentiation, and sliding windows exponentiation, can also be implemented analogously (“Handbook of Applied Cryptography” by Alfred J. Menezes, Paul C. van Oorschot and Scott A Vanstone, CRC Press October 1996).

An example for one additional exponentiation method utilizing the PKI apparatus is disclosed in the following process. In this process (right-to-left binary exponentiation), the exponent value is utilized directly, the adjustment of its bits is not required

process 3:

Input: m(>1), A′, N, E (A′ → R0, A′ + N → R1 ,N → R2,
A′ → R3, E → R4)
Output: CSA=A^{E} modN

Flag=1
For I from 0 to m−2 do

| 5.1 | If (Flag=1) and (R4_{I}=1) then R3=R0; Flag=0 |
|---|---|
| 5.2 | Else IF (R4_{I}=1) then 0→CSA ; |
| R3 = NRMM^{(s)}(R0,R3) | |
| | 0→CSA |
| 5.3 | R0=NRSÕR^{(s)}(R0) |
| 5.4 | R1=R0+R2 |

End for
0 → CSA
R0=NRMM^{(s)}(R0,R3)
R1=R0+R2
MMULBY1^{(s)}(R0)
Return CSA

The PKI operations in this process are illustrated in FIG. 7B. This process is initiated in steps 750 and 751, in which the values A′,E′, N, and m−1, are input to the PKI apparatus, and a Flag is set to “1”. The operations performed in steps 5.1. to 5.4. in the exponent process here above, begins in step 752a, in which a right shift is performed to the content of register R4. In step 752b the LSB of R4 is examined, and if it equals “1” another test is performed in step 752c, to determine if the Flag is in the state of “1”. If the Flag state is “1”, register R3 is loaded with the content of register R0, and the flag state is reset to “0”. Otherwise, if the Flag state is “0” in step 752c, the CSA content is zeroed and a NRMM^{(s)} operation is performed to the content of registers R0 and R3, the result of which is obtained in the CSA, and which is then loaded into the R3 register. The operation continues by passing the control to step 752d.

If the state of the LSB of the R4 register is not “1”, in step 752b, the operation proceed in step 752d, where the CSA content is zeroed and a NRSQR^{(s)} operation of the content of R0 is carried out, the result of which is obtained in the CSA. The NRSQR^{(s)} result is then loaded into register R0, and it is also added to the content of register R2. The addition result of the contents of the CSA and register R2 is stored in register R1. The process proceeds in step 752f, in which the loop index i is decrement by 1. In step 752e, i is examined to determine if it equal zero. If i is not zeroed, another iteration is performed as the control is passed to step 752a. Otherwise, the CSA content is zeroed and a NRMM^{(s)} operation of the R0 and R3 contents is performed, the result of which is obtained in the CSA, and loaded into register R0. The addition of the contents of register R2 and the CSA is stored in register R1, the CSA content is zeroed and a MMULBY1^{(s)} is performed. The final result (reduced) is then obtained in the CSA.

As explained before, an external control is utilized to carry out the steps of this operation.

Allowing flexibility in choosing different implementations of exponentiation processes is of importance in applications. For example, a right-to-left exponentiation process enables utilizing two PKI apparatus in parallel.

It should be also appreciated that the method of the invention substantially improves the security of the PKI apparatus, particularly against attacks, which are based on the detection of subtraction operation, as performed in the conventional Montgomery Multiplication methods. In such attacks methods the user's secret (private) key is computed by revealing the reduction operations performed (W. Schindler “A Timing Attack against RSA with the Chinese Reminder Theorem”, Second International Workshop Worcester, Mass., USA, August 2000). A common method, which is currently used, against such attacks is to perform additional (dummy) subtraction operations, which of course consumes more time and power. Since in the method of the invention subtractions are not performed, it is not possible to reveal the secret key utilizing such methods.

As was mentioned hereinabove, the method of the invention can be utilized to implement a right-to-left exponentiation process with two PKI apparatus operating in parallel. As will be appreciated by those having skill in the art, such a parallel implementations further improves the security of the system. Since it is difficult to follow and identify when and which operations are performed by such a parallel system, the opponent task becomes even more problematical.

Montgomery Interleaved Multiplication

In FIG. 5 the values loaded into each register (R0, R1, R2, R3, and R4), and the input selection of each of the multiplexers (MX1, MX2, MX3, and MX4 are described, for different steps (I,II, III, and IV) of the Montgomery interleaved multiplication. At each step, the registers are loaded with the respective values, the MUXs control input is set to provide the corresponding input, and a process of s iterations is performed, for calculating the respective product.

In the following discussion, the Montgomery interleaved modular multiplication of A·B mod N, wherein A, B, and N, are 2n-bit values, is described. Each of the integer values, A, B, and N, is treated as a pair of n-bit partial values. The partial values of A=A¹*2ⁿ+A⁰, for example, are denoted as follows; A=(A¹,A⁰), wherein A¹ denotes the n MSBs of A, and A⁰ denotes the n LSBs of A. Similarly, the partial values of B=B¹*2n+B⁰ and N=N¹*2ⁿ+N⁰, are denoted by B=(B¹,B⁰), and N=(N¹,N⁰). This embodiment may be further modified (with software) to allow computation of A·B mod N, for A, B, and N, of any length. In other forms, each integer may consist of l partial values, each of which is of n-bit.

In step I, the computation of (A⁰*B⁰+N⁰*K⁰)/2⁻ⁿ is performed by loading registers R0, R1, R2, and R3, with B⁰,B⁰+N⁰,N⁰, and A⁰, respectively. In addition, the control inputs of MX1, MX2, MX3, and MX4, are set to select the inputs of K₁, K₁, “0”, R3, respectively. The result (A⁰*B⁰+N⁰*K⁰)/2⁻ⁿ A⁰*B⁰*2^{-s} modN⁰ remains in the CSA. Since in this step MX2 selects the K₁ output, register R4 is loaded with bits of the K⁰ value, which are required for the computation of the next step.

In step II, regular multiplication is performed, to calculate A⁰·B¹+N¹·K⁰+CSA_{(I)}, wherein CSA_{(I)} is the result that was obtained in the previous step, step I. The values B¹,B¹+N¹,N¹, and A⁰, are loaded into the R0, R1, R2, and R3, registers, respectively, and the control inputs of MX1, MX2, MX3, and MX4, are set to select the inputs of R₄, CSA₀, “0”, R3, respectively. It should be noted that the right shift of the bits of R3 is a cyclic bit rotation, so that there is actually no need to reload R3 with the value of A⁰. Since in this step the apparatus is utilized for the calculation of regular multiplication, the n LSBs of the result are fed into the serial in of the R4 register, and the n MSBs of the result remain in the CSA.

In the next step, step III, the calculation of (A¹*B⁰+N⁰*K¹+R4*2ⁿ+CSA)/2⁻ⁿ modN⁰ is carried out. For this purpose, prior to any operation in this step, the value stored in the R4 register is stored in the CSA, and the content of the CSA is stored in the R4 register. In addition, registers R0, R1, R2, and R3, are loaded with the values, B⁰,N⁰+B⁰,N⁰, and A¹, respectively, and the control inputs of MX1, MX2, MX3, and MX4, are set to select the inputs of K₁, K₁, R4, R3, respectively. During the operation of this step, the content of the R4 register is loaded with the bits, K₁¹, of K¹. The result of this step remains in the CSA for the calculation of the final step.

In the last step, IV, the regular multiplication of A¹*B¹+N¹*K¹+CSA_{(III)} is performed, wherein CSA_{(III)} is the result that was obtained in step III. The values of registers R0, R1, R2, and R3, are loaded with the values B¹,B¹+N¹,N¹, and A¹, respectively, and the control inputs of MX1, MX2, MX3, and MX4, are set to select the inputs of R4, CSA₀, “0”, R3, respectively. During this step the n LSBs of the result are loaded into the R4 register, and the n MSBs (which may also be of n+1 bits) of the result are obtained in the CSA.

The final result of each of the steps in this process (steps I to VI) may be greater than N, and thus reduction may be required. If it is required, reduction is performed by software after each step. Alternatively, one may implement the same method of interleaved multiplication by utilizing an extended non-reduced approach without needing to reduce the obtained result after each step. In addition, the computation of greater values may be carried out utilizing software for storing temporary result of the interleaved multiplication.

The above examples and description have of course, been provided only for the purpose of illustration, and are not intended to limit the invention in any way. As will be appreciated by the skilled person, the invention can be carried out in a great variety of ways, employing different techniques from those described above, all without exceeding the scope of the invention.

1. A method for carrying out modular arithmetic computations involving multiplication operations by utilizing a non-reduced and extended Montgomery multiplication between a first A and a second B integer values, in which the number of iterations required is greater than the number of bits n of an odd modulo value N, comprising:
a) providing an accumulating device (S) capable of storing n+2 bit values, of adding n+2-bit values (X) to it content (S+X→S), and of dividing its content by 2 (S/2→S);
b) whenever desired, setting the content of said device to a zero value (“0”→S) and performing in said device at least s(>n+1) iterations, while in each iteration choosing one bit, in sequence, from the value of said first integer value A (A_{I}; 0≦I≦s−1), starting from its least significant bit (A₀):
b.1) adding to the content of said device S the product of the selected bit A_{I} and said second integer value B (S+A_{I}*B→S);
b.2) adding to the resulting content of said device the product of its current least significant bit S₀ and N(S+S₀*N→S);
b.3) dividing the resulting content of said device by 2 (S/2→S); and
b.4) obtaining a non-reduced and extended Montgomery multiplication: result by repeating steps b.1) to b.3) s−1 additional times while in each time using the previous result (S).

2. a method according to claim 1, wherein the Montgomery multiplication result is obtained by unifying steps b.1) to b.3) into a single step, by:
a) providing a first storing device (R2) for storing the modulo value N;
b) providing a second storing device (R0) for storing the value of the second integer B;
c) providing a third storing device (R1) for storing the sum of the modulo N and said second integer value B;
d) providing an arbitration circuitry having a first (In1), second (In2) and third (In3), inputs from said first (R2), second (R0) and third (R1), storage devices respectively, and having an additional zero input (In0), said arbitration device receives a first (C1) and a second (C0) control inputs, and is capable of selecting one of its other inputs as it output, according to the following steps:
d.1) whenever its first (C1) and second (C0) control inputs are zero, selecting said additional zero input (In0);
d.2) whenever its first control input (C1) is one and its second control input (C0) is zero, selecting its second input (In2);
d.3) whenever its first control input (C1) is zero and its second control input (C0) is one, selecting its first input (In1);
d.4) whenever its first (C1) and second (C0) control inputs are one, selecting said third input (In3);
wherein the selected input is provided as the output of said arbitration circuitry which is attached to the input of the accumulating device.
e) applying the bits of the first integer value A (A₁; 0≦I≦s), one by one, in sequence, starting from its least significant bit (A₀), to said first control input (C1); and
f) providing circuitry for producing the state (K₁) of said second control input (C0) according to the state of the selected bit of said first integr value (A₁), the state of the least significant bit of said second integer value (B₀)) and according to the state of the least significant bit of said accumulating device (S₀).

3. A method according to claims 2, wherein the state (K₁) of the second control input (C0) is produced by performing the following steps:
a) producing a value of one (K₁=“1”) whenever:
a.1) the state of the first control input (C1) and the state of the least significant bit of the second integer value (B₀) are one, and the state of the least significant bit of the accumulating device (S₀) is zero; or
a.2) the state of said first control input (C1) and the state of the least significant bit (B₀) of said second integer value B are in different state, and the state of the least significant bit (S₀) of said accumulating device is one; and
b) otherwise, producing a zero value (K₁=“0”).

4. A method according to claim 3, wherein the circuitry utilized for producing the state of the second control input (C0) comprises a logical AND gate, and a logical XOR gate, where the inputs of said logical AND gate are receiving the states of the first control input (C1) and the state of the least significant bit (B₀) of the second integer value B, and where the inputs of said logical XOR gate are receiving the output from said logical AND gate and the state of the least significant bit of said accumulating device (S₀), and where the output of said logical XOR gate is utilized as the state of the second control input (C0).

5. A method according to claims 1 or 2, wherein the number of iterations s utilized for carrying out the Montgomery multiplication is n+2, thereby obtaining an extended Montgomery multiplication result in which n+2 iterations are performed.

6. A method according to claim 2, further comprise allowing modular arithmetic operations to be carried out, by performing the following steps:
a) utilizing for the first (R2), second (R0), and third (R1) storage devices an n+2 bits shift registers having a serial input into their most significant bit locations, and which may be capable of outputting their content in parallel;
b) providing said first storage device (R2) with a serial output, from its least significant bit location (R2₀), and allowing it to perform cyclic bit rotation;
c) allowing said second storage device (R0) to receive on its serial input the least significant bit (S₀) of the accumulating device;
d) providing a fourth storage device (R3) capable of serially outputting it content, bit by bit in sequence (R3₁ I=0,2, . . . , n+1), starting from its least significant bit (R3₀), said fourth storage device is capable of storing n+2 bits, and of performing cyclic bit rotation to it content;
e) providing a fifth storage device (R4) having a serial input and a serial output, and which is capable of storing values of n+2 bits;
f) providing a sixth storage device (R5) capable of serially outputting it content, bit by bit in sequence (R5₁ I=0,1,2, . . . , n+1), starting from its least significant bit, said fourth storage device is capable of storing n+2 bits;
g) providing a first arbitration device (MX1) having a first input from said fifth storage device (R4₁), and a second input from the circuitry producing the state of the second control input (K₁), the output of said fast arbitration device is attached to the second control input (C0);
h) providing a second arbitration device (MX2) having a first input being equal to the least significant bit of the accumulating device (S₀), a second input received from the output of said circuitry (K₁), and a third input connected to the serial output (R4₁) of said fifth storage device (R4), the output of said second arbitration device is attached to the serial input of said fifth storage device (R4);
i) providing a third arbitration device (MX3) having a first input which is constantly fed with a zero value (“0”), and a second input received from the serial output of said fifth storage device (R4₁), the output of said third arbitration device is connected to a serial input of said accumulating device;
i) providing a fourth arbitration device (MX4) having a first input connected to the serial output of said sixth storage device (R5₁), and a second input connected to the serial output of said fourth storage device (R3₁), the output of said fourth arbitration device is connected to the first control input (C1); and
k) providing an adder capable of performing serial addition of n+2 bit values, said adder receives a first input from the least significant bit location of the accumulating device (S₀), and a second input from the serial output of said first storage device (R2), the output of said adder is connected to the serial input of said third storage device (R1).

7. A method according to claim 6, wherein the accumulating device consist of n+2 addition and latching stages, each of which consists of a first and a second flip flop devices and a full adder device having three inputs, except for the first stage wherein said second flip flop is excluded, the method comprising:
a) connecting the first input of said full adder to the output of a first flip-flop device;
b) connecting the second input of said full adder to the output of a second flip flop device of the subsequent addition and latching stage; and
c) connecting the third input of said full adder to the respective bit output of the arbitration device (MUX₁ 0≦i≦n+1).

8. A method according to claim 7, further comprising adding the output from the third arbitration device (MX3), via the serial input of said accumulating device, to the addition result of the (n+1)-th addition and latching stage by performing the following steps:
a) providing the (n+1)-th addition and latching stages with a first and second half adder devices, and a third flip flop device;
b) connecting the input of the first-flip flop device to the sum output of said second half adder;
c) connecting the input of the second flip flop device to the carry output of said second half adder, and connecting the output of said flip flop device to the second input of the full adder of the (n+2)-th addition and latching stage;
d) connecting the first input of said second half adder to the carry output of the full adder of the (n+1)-th addition and latching stage, and it second input, to the carry output of said first half adder;
e) connecting the first input of said first half adder to the sum output of said full adder, and connecting the second input of said second half adder to the output of the third arbitration device (MX3); and
f) connecting the input of said third flip flop device to the sum output of said first half adder, and connecting it output to the second input of the full adder of the (n−1)-th addition and latching stage.

9. A method according to claim 3 and 8, wherein the state of the second control input (C0) is determined utilizing the least significant bit of the second storage device (R0), the output of the fourth arbitration device (MX4), the carry output of the full adder of the first addition and latching stage, and the sum output of the full adder of the second addition and latching stage, the method comprising:
a) connecting the least significant bit of said second storage device (R0) and the output of said fourth arbitration device (MX4), to the inputs of an AND logical gate;
b) providing an additional half adder and an additional flip flop device;
c) connecting the first input of said half adder to the sum output of the full adder of the second addition and latching stage, and its second input to the carry output of the full adder of the first addition and latching stage;
d) connecting the slum output of said half adder to the input of said additional flip flop device; and
e) connecting the output of said AND logical gate and the output of said flip flop device to the inputs of a XOR gate, and utilizing the output of said XOR gate to determine the state of said second control input (C0).

10. A method according to claim 9, further comprising carrying out non-reduced Montgomery squaring of an integer value B, by performing the following steps:
a) loading the first (R2), second (R0), and third (R1), storage devices with the values of the modulus N, said integer B, and the sum of said modulus and said integer (N+B), respectively;
b) setting the first (MX1), second (MX2), third (MX3) and fourth (MX4), arbitration devices to select the inputs of the circuitry for producing the state (K₁) of the second control input (C0), the circuitry for producing the state (K₁) of the second control input (C0), the zero value (“0”), and the output of the sixth storage device (R5), respectively;
c) loading the content of the sixth storage device (R5) with the content of the second storage device (R0), and loading the content of the accumulating device with a zero value;
d) performing the non-reduced and extended Montgomery multiplication wherein the content of said sixth storage device (R5) is shifted by one bit to the right in each cycle; and
e) obtaining the non-reduced Montgomery squaring result in the accumulating device.

11. A method according to claim 9, further comprising carrying out Montgomery multiplication of a first (A) and second (B) integer values, by performing the following steps:
a) loading the first (R2), second (R0), third (R1), and fourth (R3) storage devices with the values of the modulus N, said second integer (B), the sum of said modulus and said second integer (N+B), and said first integer (A), respectively;
b) setting the first (MX1), second (MX2), third (MX3) and fourth (MX4), arbitration devices to select the inputs of the circuitry for producing the state (K₁) of the second control input (C0), the circuitry for producing the state (K₁) of the second control input (C0), the zero value (“0”), and the output of the fourth storage device (R3), respectively;
c) loading the content of the accumulating device with a zero value;
d) performing the non-reduced and extended Montgomery multiplication wherein the content of said fourth storage device (R3) is shifted by one bit to the right in each cycle; and
e) obtaining the non-reduced Montgomery multiplication result in the accumulating device.

12. A method according to claim 9, further comprising carrying out modular exponentiation A^{E} modN, comprising:
a) pre-calculating the adjusted operand value A′=A*2^{s} modN;
b) composing an adjusted value for the exponent E=(eₘ₋₁,eₘ₋₂, . . . , e₁,e₀)₂ by reversing its bit order and eliminating the most significant bit eₘ₋₁, to obtain the adjusted value E′=(e₀,e₁, . . . , eₘ₋₂)₂;
c) loading the content of the first, second, third, and fifth, storage devices with the values of the modulus N, said adjusted operand (A′), the sum of said modulus and said adjusted operand (N+A′), and the adjusted exponent value E′, respectively, obtaining the bit length m of said exponent value E and performing the following steps:
c.1) right shifting the content of said fifth storage device (R4);
c.2) performing non-reduced Montgomery squaring to obtain the non-reduced Montgomery square of the content of said third storage device (R3) in the accumulating device;
c.3) loading the content of said third storage device (R3) with the content of said accumulating device;
c.4) loading the content of said third storage device (R1) with the sum of the content of said first storage device (R2) and the content of said accumulating device;
c.5) if the least significant bit (R4₀) of said fifth storage device equals. “1” performing non-reduced and extended Montgomery multiplication to obtain the non-reduced Montgomery multiplication result of the contents of said second storage device (R0) and said fourth storage device (R3), in said accumulating device, loading the content of said second storage device (R0) with the content of said accumulating device, and loading the content of said third (R1) storage device with the sum of the contents of said first storage device (R2) and said accumulating device; and
c.6) repeating steps c.1) to c.5) additional m−2 times; and
d) performing non-reduced and extended Montgomery multiplication of the content of said second storage device (R0) by 1 to obtain the final reduced result in said accumulating.

13. A method according to claim 9, further comprising carrying out modular exponentiation A^{E} modN by performing the following steps:
a) pre-calculating the adjusted operand value A′=A*2^{s} modN;
b) loading the content of the first (R2), second (R0), third (R1), and fifth (R4), storage devices with the values of the modulus N, said adjusted operand (A′), the sum of the modulus and the adjusted operand (N+A′), and the exponent value E, obtaining the bit length m of said exponent value E, setting a flag to “1”, and performing the following steps:
b.1) right shifting the content of said fifth storage device (R4);
b.2) if the least significant bit (R4₀) of said fifth storage device equals “1” checking the state of said flag, and if it does not equal “1” performing non-reduced and extended Montgomery multiplication to obtain the non-reduced and extended Montgomery multiplication result of the contents of said second storage device (R0) and said fourth storage device (R3), in said accumulating device, loading the content of said fourth storage device (R3) with the content of said accumulating device, otherwise loading the content of said fourth storage device (R3) with the content of said second storage device (R0) and resetting the state of said flag to “0”;
b.3) performing extended and non-reduced Montgomery squaring to obtain the extended and non-reduced Montgomery square of the content of said second storage device (R0) in the accumulating device;
b.4) loading the content of said second storage device (R0) with the content of said accumulating device;
b.5) loading the content of said third storage device (R1) with the sum of the content of said first storage device and the content of said accumulating device;
b.6) repeating steps b.1) to b.5) m−1 additional times; and
c) performing extended and non-reduced Montgomery multiplication to obtain the extended and non-reduced Montgomery multiplication result of the contents of said second storage device (R0) and said fourth storage device (R3), in said accumulating device, loading the content of said second storage device (R0) with the content of said accumulating device, loading the content of said third storage device (R1) with the sum of the content of said first storage device (R2) and the content of said accumulating device, and performing extended and non-reduced Montgomery multiplication of the content of said second storage device (R0) by 1 to obtain the final reduced result in said accumulating device.

14. A method according to claim 9, further comprising carrying out modular multiplication of a first (A=A¹*2ⁿ+A⁰) and a second (B=B¹*2ⁿ+B⁰) integer values, where said first integer, second integer, and the modulus (N), are of 2×n bits, by performing the following steps:
a) computing the Montgomery multiplication (MMUL(A⁰,B⁰)) of the n least significant bits of said first integer value (A⁰) and of said second integer value (B⁰), by performing the following steps:
a.1) loading the first (R2), second (R0), third (R1), and fourth (R3) storage devices, with the n least significant bits (N⁰) of said modulus value (N), the n least significant bits (B⁰) of said second integer value (B), the sum. (B⁰+N⁰) of the n least significant bits of said modulus value (N) and of the n least significant bits (B⁰) of said second integer value (B), and the n least significant bits (A⁰) of said first integer value (A), respectively;
a.2) setting the first (MX1), second (MX2), third (MX3), and fourth (MX4), arbitration devices for selecting the input of the circuitry for producing the state (K₁) of the second control input (C0), the circuitry for producing the state (K₁) of the second control input (C0), the zero value (“0”), and the fourth storage device (R3) input, and resetting the content of the accumulating device to zero, if it is required;
a.3) carrying out Montgomery multiplication and obtaining the result (S₍₁₎) in said accumulating device, and the bits state (K_{I} 0≦I≦n−1) of the second control input (K⁰) in the fifth register (R4);
b) computing the value of A⁰*B¹+N¹*K⁰+S(_{I}) of the n least significant bits of said first integer value (A⁰), the n most significant bits of said second integer value (B¹), the n most significant bits of said modulus value (N¹), the n-bit value (K⁰) obtained in the fifth register (R4), and the result obtained in step a) (S_{(I)}) by performing the following steps:
b.1) loading the first (R2), second (R0), third (R1), and fourth (R3) storage devices, with the n most significant bits (N¹) of said modulus value (N), the n most significant bits (B¹) of said second integer value (B), the sum (B¹+N¹) of the n most significant bits of said modulus value (N) and of the n most significant bits of said second integer value (B), and the n least significant bits (A⁰) of said first integer value (A), respectively,
b.2) setting the first (MX1), second (MX2), third (MX3), and fourth (MX4), arbitration devices for selecting the input of said fifth register (R4), the least significant bit of said accumulating device (S₀), the zero value (“0”), and the fourth storage device (R3) input;
b.3) carrying out the computation and obtaining the most significant bits of the result in said accumulating device (S_{(II)}) and the least significant bits of said result in said fifth storage device (R₍₄₎);
c) computing result of addition of the Montgomery multiplication of the n most significant bits of said first integer value (A¹) and the n least significant bits of said second integer value (B⁰), with the result obtained in step b) (R4_{(II)}, S_{(II)}), by performing the following steps:
c.1) loading the first (R2), second (R0), third (R1), and fourth (R3) storage devices, with the n least significant bits (N⁰) of said modulus value (N), the n least significant bits (B⁰) of said second integer value (B), the sum (B⁰+N⁰) of the n least significant bits of said modulus value (N) and of the n least significant bits (B⁰) of said second integer value (B), and the n most significant bits (A¹) of said first integer value (A), respectively;
c.2) loading the content of the accumulating device (S) with the n least significant bits of the result obtained in the step b) (R4_{(II)}), and loading the content of said fifth storage device (R4) with n most significant bits of the result obtained in the step b) (S_{(II)});
c.3) setting the first (MX1), second (MX2), third (MX3), and fourth (MX4), arbitration devices for selecting the input of the circuitry for producing the state (K₁) of the second control input (C0), the circuitry for producing the state (K₁) of the second control input (C0), the input from the fifth storage device (R4), and the fourth storage device (R3) input;
c.4) carrying out Montgomery multiplication and obtaining the result (S_{(III)}) in said accumulating device, and the bits state (K₁ 0≦I≦n−1) of the second control input (K¹) in the fifth register (R4);
d) computing A¹*B¹+N¹*K¹+S_{(III)} of the n most significant bits of said first integer value (A¹), the n most significant bits of said second integer value (B¹), the n most significant bits of said modulus value (N¹), the n-bit value (K¹) obtained in the fifth register (R4), and the result obtained in, step c) (S_{(III)}) by performing the following steps:
d.1) loading the first (R2), second (R0), third (R1), and fourth (R3) storage devices, with the n most significant bits (N¹) of said modulus value (N), the n most significant bits (B¹) of said second integer value (B), the sum (B¹+N¹) of the n most significant bits of said modulus value (N) and of the n most significant bits of said second integer value (B), and the n most significant bits (A¹) of said first integer value (A), respectively;
d.2) setting the first (MX1), second (MX2), third (MX3), and fourth (MX4), arbitration devices for selecting the input of said fifth register (R4), the least significant bit of said accumulating device (S₀), the zero value (“0”), and the fourth storage device (R3) input; and
d.3) carrying out the computation and obtaining the most significant bits of the result in said accumulating device (S_{(IV)}) and the least significant bits of said result in said fifth storage device (R_{(IV)}).

15. A method according to claim 14, further comprising carrying out modular multiplication of a first
$$( A = {\sum }_{i = 0}^{q - 1} {A}^{i} * {2}^{i} )$$
and a second
$$( B = {\sum }_{i = 0}^{q - 1} {B}^{i} * {2}^{i} )$$
integer values, where said first integer, second integer, and the modulus
$$( N = {\sum }_{i = 0}^{q - 1} {N}^{i} * {2}^{i} ) ,$$
may be of more than 2×n bits, where the computation is carried out by computing intermediate results of the multiplication of 2×n bits subsequent fractions of said first integer and second integer.

16. Apparatus for carrying out extended and non-reduced Montgomery multiplication of a first (A) and second (B) integer values, in which the number of iterations (s) required is greater the number of bits (n) in the modulo value (N), and in which the Montgomery multiplication result is smaller than twice the modulo value (2×N), comprising:
a) a first storage device (R2) for storing the modulo value (N);
b) a second storage device (R0) for storing the value of said first integer values (A);
c) a third storage device (R1) for storing the sum of said first integer value and said modulo (A+M);
d) an arbitration circuitry having a first (In1), second (In2) and third (In3), inputs from said first (R2), second (R0), and third (R1), storage devices, and having a fourth input which is zero (“0”), said arbitration device receives a first (C1) and a second (C0) control inputs, and thereby is capable of selecting one of it other inputs as it output, that is attached to the input of the accumulating device;
e) circuitry for producing the state (K₁) of said second control input (C0) according to the state of a selected bit of said first integer value (A₁), the state of the least significant bit of said second integer value (B₀), and according to the state of the least significant bit of said accumulating device (S₀); and
f) an accumulating device (S) capable of storing n+2 bits values, of adding n+2-bits values (X) to it content (S+X→S), and of dividing it content by 2 (S/2→S).

17. Apparatus according to claims 16, in which the circuitry utilized for producing the state (K₁) of the second control input comprises:
Circuitry for producing a value of one whenever:
the state of the selected bit (A₁) and the state of the least significant bit of the second integer value (B₀) are one, and the state of the least significant bit of the accumulating device (S₀) is zero; or
the state of said selected bit (A₁) and the state of the least significant bit (B₀) of said second integer value are in different state, and the state of the least significant bit (S₀) of said accumulating device is one;
said circuitry produces a zero value in all other cases.

18. Apparatus according to claim 17, in which the first (R2), second (R0), and third (R1) storage devices are n+2 bits shift registers having a serial input into their most significant bit locations, and which may be capable of outputting their content in parallel.

19. Apparatus according to claim 17, in which said first storage device (R2) is having a serial output, from its least significant bit location (R2₀), allowing it to perform cyclic bit rotation.

20. Apparatus according to claims 17, 18, and 19, further including means for allowing modular arithmetic operations to be carried out, that comprises:
a) means for connecting the serial input of the second storage device (R0) to the least significant bit (S₀) of the accumulating device (S);
b) a fourth storage device (R3) capable of serially outputting it content, bit by bit in sequence (R3₁ I=0,1,2, . . . , n+1), starting from its least significant bit (R3₀), said fourth storage device is capable of storing n+2 bits, and of performing cyclic bit rotation to it content;
c) a fifth storage device (R4) having a serial input and a serial output, and which is capable of storing values of n+2 bits;
d) a sixth storage device (R5) capable of serially outputting it content, bit by bit in sequence (R5₁ I=0,1,2, . . . , n+1), starting from its least significant bit, said fourth storage device is capable of storing n+2 bits;
e) a first arbitration device (MX1) having a first input from said fifth storage device (R4₁), and a second input from the circuitry producing the state of the second control input (K₁), the output of said first arbitration device is attached to the second control input (C0);
f) a second arbitration device (MX2) having a first input being equal to the least significant bit of the accumulating device (S₀), a second input received from the output of said circuitry (K₁), and a third input connected to the serial output (R4₁) of said fifth storage device (R4), the output of said second arbitration device is attached to the serial input of said fifth storage device (R4);
g) a third arbitration device (MX3) having a first input which is constantly fed with a zero value (“0”), and a second input received from the serial output of said fifth storage device (R4₁), the output of said third arbitration device is connected to a serial input of said accumulating device;
h) a fourth arbitration device (MX4) having a first input connected to the serial output of said sixth storage device (R5₁), and a second input connected to the serial output of said fourth storage device (R3₁), the output of said fourth arbitration device is connected to the first control input (C1); and
i) an adder capable of performing serial addition of n+2 bit values, said adder receives a first input from the least significant bit location of the accumulating device (S₀), and a second input from the serial output of the first storage device (R2), the output of said adder is connected to the serial input of the third storage device (R1).

21. Apparatus according to claim 20, in which the accumulating device consist of n+2 addition and latching stages, each of which consists of a first and a second flip flop devices and a full adder device having three inputs, except for the first stage wherein said second flip flop is excluded, comprising:
a) means for connecting the first input of said full adder to the output of a first flip-flop device;
b) means for connecting the second input of said full adder to the output of a second flip flop device of the subsequent addition and latching stage; and
c) means for connecting the third input of said full adder to the respective bit output of the arbitration device (MUX₁ 0≦i≦n+1).

22. Apparatus according to claim 21, further including means for adding the output from the third arbitration device (MX3), via the serial input of said accumulating device, to the addition result of the (n+1)-th addition and latching stage, that comprises:
a) a fist and second half adder devices, and a third flip flop device;
b) means for connecting the input of the first flip flop device to the sum output of said second half adder;
c) means for connecting the input of the second flip flop device to the carry output of said second half adder, and for connecting the output of said flip flop device to the second input of the full adder of the (n+2)-th addition and latching stage;
d) means for connecting the first input of said second half adder to the carry output of the full adder of the (n+1)-th addition and latching stage, and it second input, to the carry output of said first half adder;
e) means for connecting the first input of said first half adder to the sum output of said fall adder, and for connecting the second input of said second half adder to the output of the third arbitration device (MX3); and
f) means for connecting the input of said third flip flop device to the sum output of said first half adder, and connecting it output to the second input of the full adder of the (n−1)-th addition and latching stage.

23. Apparatus according to claims 17 and 22, in which the state of the second control input (C0) is determined utilizing the least significant bit of the second storage device (R0), the output of the fourth arbitration device (MX4), the carry output of the full adder of the first addition and latching stage, and the sum output of the full adder of the second addition and latching stage, comprising:
a) means for connecting the least significant bit of said second storage device (R0) and the output of said fourth arbitration device (MX4), to the inputs of an AND logical gate;
b) an additional half adder and an additional flip flop device;
c) means for connecting the first input of said half adder to the sum output of the full adder of the second addition and latching stage, and its second input to the carry output of the full adder of the first addition and latching stage;
d) means for connecting the sum output of said half adder to the input of said additional flip flop device; and
e) means for connecting the output of said AND logical gate and the output of said flip flop device to the inputs of a XOR gate, and utilizing the output of said XOR gate to determine the state of said second control input (C0).
